(19) United States
(12) Patent Application Publication
(10) Pub. No.: US 2003/0172163 A1
(43) Pub. Date: Sep. 11, 2003

(54) Server load balancing system, server load balancing device, and content management device

(75) Inventors: Norihito Fujita, Tokyo (JP); Atsushi Iwata, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/377,601

(22) Filed: Mar. 4, 2003

(30) Foreign Application Priority Data
Mar. 5, 2002 (JP) 2002-059326

(51) Int. Cl. G06F 15/173

(52) U.S. Cl. 709/226

(57) ABSTRACT

A server load balancing system for distributing a content delivery to a client among a plurality of content servers, comprises a destination server determining policy setting unit for setting selection criteria for determining a content server for delivering the content for every content characteristic and a destination server determining unit for determining the content server for delivering the content requested from the client, according to the selection criteria corresponding to the characteristic of the requested content.

### BACKGROUNDS OF THE INVENTION

1. Field of the Invention

The present invention relates to server load balancing, and more particularly to a system and a device for server load balancing, and a content management device and a content server for selecting an optimum server, as for a request from a client for obtaining delivery content such as the WWW (World Wide Web) content and the streaming content, and sending the above request to the selected server.

2. Description of the Related Art

Recently, in delivery of the WWW content and the streaming content through the Internet, various methods have been proposed, for distributing the load of a server and shortening the client perceived response time, by distributing the same content to a plurality of servers.

Under such a circumstance that the content is distributed within a network, a server load balancing device for determining which server to send a client request for obtaining the content, is necessary.

As the conventional technique, a device for predicting the load of a server for every service through simulation and distributing each client request so as to prevent from an excessive load and a heavy load on the server is disclosed in Japanese Patent Publication Laid-Open (Kokai) No. 2001-101134. In the device disclosed in the above publication, a destination server is selected by taking notice of only the server load and a destination server is selected for every service.

Further, a method of selecting a destination server in a client is disclosed in Japanese Patent Publication Laid-Open (Kokai) No. Heisei 09-198346. The server selecting method disclosed in this publication is characterized by storing a selection policy into an inquiry message to a directory server to cope with various server selecting requests from individual clients. The directory server, upon receipt of the inquiry, selects the optimum server based on the selection policy stored in the message and responds to the client. This method is the selecting method in the side of a client, and therefore, the client has to introduce this method. When a server load balancing device can support various selection criteria as in this method, it is possible to realize the same service in a way of filtering without changing the method on the side of the client.

The above-mentioned conventional technique, however, has the following problems.

At first, within a content server, contents are not necessarily grouped in every characteristic thereof, but even if they are done, they are grouped only in the static characteristic.

Generally, the content within a content server is arranged to be easily controlled by a content manager and it is not grouped from the viewpoint of the characteristic of each content. For example, under a directory “/news/” about news, generally, various content such as article, picture, and image of news, having various characteristics in the file size and the media type is arranged in a mixed way. No consideration is taken to the dynamic characteristic (parameter) such as the access frequency to each content. At this time, in the server load balancing device on the side of a client, when the same content server is selected as the destination as for the “/news/” directory, there is such a possibility that the selected content server may not be always the optimum from the viewpoint of the content acquisition delay. Accordingly, the destination server selection should be performed by every content group having the same characteristic from the viewpoint of the size and the access frequency of each content.

At second, in the server load balancing device, it is impossible to change selection criteria of a destination server depending on the characteristic of each content, thereby preventing from realizing the effective load balancing.

In the conventional technique, the selection criteria of a destination server are fixed and the selection criteria cannot be changed depending on the characteristic of each content. For example, when considering two kinds of contents including the small-sized content and the large-sized content, the response time in a client much depends on a delay in the transmission path in the case of the small-sized content, while it much depends on a usable bandwidth of the transmission path in the case of the large-sized content. In this case, the conventional technique could not use the different selection criteria for the two and more kinds of the content.

At third, when each server load balancing device arranged on the side of a client individually selects a destination server, load concentrates on the same server, hence to deteriorate the quality of the delivery.

Especially, in the case of delivering the continuous media content such as stream and sound, when accesses concentrate on the same server, expected delivery quality cannot be obtained and a destination server must be selected again. Further, when all the connections during the delivery are switched at once, there may cause such oscillatory phenomenon as deteriorating the delivery quality again owing to the access concentration on a new deliver server after switching and repeating the switching operation to another deliver server.

At fourth, since a server load balancing device such as selecting a destination server by the content or the content group has to determine a destination server after watching the contents of a request from a client, the layer 7 switch must be used.

If using the layer 7 switch, it is possible to distribute each request from a client to each destination server set for every content, but its performance is low and its cost is expensive compared with a device of switching with a lower layer such as the layer 3 switch and the layer 4 switch. Accordingly, it is preferable that the same function can be realized by using a device capable of switching with a low layer without necessity of watching the contents of a request.

### SUMMARY OF THE INVENTION

In order to solve the above problems of the conventional technique, a first object of the present invention is to provide a server load balancing system, a content management device, and a content management program capable of automatically grouping the content within a content server depending on their characteristics in a static and dynamic way.

In order to solve the above problems of the conventional technique, a second object of the present invention is to provide a server load balancing system, a server load balancing device, and a server load balancing program capable of changing selection criteria of a destination server depending on the characteristic of each content.

In order to solve the above problems of the conventional technique, a third object of the present invention is to provide a server load balancing system, a server load balancing device, a content server, and a content delivery management program capable of proper distributing processing so as to prevent from load concentration on a specified server in delivery of the continuous media content.

In order to solve the above problems of the conventional technique, a fourth object of the present invention is to provide a server load balancing system, a server load balancing device, and a server load balancing program capable of realizing selection of a destination server by the content group, without the function of the layer 7 switch.

According to the first aspect of the invention, a server load balancing system for distributing a content deliver to a client among a plurality of content servers, comprises means for determining the content server to which a destination of a content delivery request received from the client is to be transferred, by using at least characteristic of the content and resource information about the content server.

In the preferred construction, the content server to which the content delivery request received from the client is to be transferred is determined again according to a change of the resource information.

In another preferred construction, the content delivery request received from the client is transferred to the content server to which the content delivery request is to be transferred, the content server being set for the content.

In another preferred construction, based on a destination IP address and a destination port number of a packet received from the client, the content requested by the client is recognized and the packet is transferred to the content server set for the content.

In another preferred construction, the content delivered by the content server is classified into a plurality of groups depending on the characteristic of the content, and the content classified into the above groups is collected together into every group.

According to the second aspect of the invention, a server load balancing device for selecting a content server that delivers content to a client, from a plurality of content servers, comprises means for determining the content server to which a content delivery request received from the client is to be transferred, by using at least characteristic of the content and resource information about the content server.

In the preferred construction, the resource information includes at least one or a plurality of resource parameters, a second resource parameter different from a first resource parameter is predicted or extracted by using the first resource parameter, and the resource information includes the second resource parameter predicted or extracted.

In another preferred construction, the destination server determining means obtains a candidate content server for a destination of the request, by using a URL or a portion of the URL of the content requested from the client, and determines the content server to which the content is delivered, from the candidate content server.

In another preferred construction, the portion of the URL is a URL prefix that is head portion of the URL or a file extension in the URL or a combination of the both.

In another preferred construction, the destination server determining means obtains the candidate content server for delivering the content requested from the client, by inquiring of the content servers existing within the network or a content management device that is a device for managing the content within the content servers.

In another preferred construction, the destination server determining means obtains characteristic of the client, by inquiring of the content servers existing within the network or a content management device that is a device for managing the content within the content servers.

In another preferred construction, the destination server determining means creates an FQDN by using a URL or a portion of the URL of the content to be obtained by the request, obtains a list of IP address for the FQDN with the FQDN as a key, and defines a content server corresponding to each IP address of the list as the candidate content server for delivering the content requested from the client.

In another preferred construction, the list of IP address for the FQDN is obtained from a DNS server.

In another preferred construction, a packet for requesting the content deliver, which is sent by the client is transferred to the content server, after changing the destination IP address of the packet to the IP address of the content server determined as the content server for delivering the content to the client.

In another preferred construction, a packet for requesting the content deliver, which is sent from the client, is transferred to the content server, after resolving a MAC address corresponding to the IP address of the content server determined as the content server for delivering the content to the client and changing the MAC address of the packet to the resolved MAC address.

In another preferred construction, the content server to which the delivery request of the content received from the client is to be transferred is again determined according to a change of the resource information.

In another preferred construction, priority is set at the respective content servers to which the delivery request of the content received from the client is to be transferred, by using at least the characteristic of the content and the resource information.

In another preferred construction, the priority is set again according to a change of the resource information.

In another preferred construction, in consideration of the current priority, before resetting the priority according to the resource information of the respective content servers, a fluctuation from the current priority is restrained to a constant degree, and then the priority is reset.

In another preferred construction, the time of resetting the priority is delayed by a time varying in probability and the priority is reset at the delayed time.

In another preferred construction, at the delayed time, whether the priority is reset or not is judged again and when judging that the priority is reset, the priority is reset again.

In another preferred construction, the server load balancing device comprises means for determining the content server for sending the content to the client, based on a destination IP address and destination port number of a packet for requesting a content deliver, received from the client, and transferring the received packet for requesting the content delivery, to the determined content server, wherein

an FQDN indicating the destination IP address and destination port number uniquely is newly created by using the information of the destination IP address and destination port number of the received packet,

a candidate content server for delivering the content to the client, which server is the transfer destination of the received packet is obtained by inquiring of a DNS server with the newly created FQDN as a key, and

the content server for delivering the content to the client is determined from the candidate.

In another preferred construction, the FQDN is resolved by inquiring of the DNS server with the destination IP address as a key,

an FQDN uniquely indicating the destination port number and the resolved FQDN is newly created by using the information of the resolved FQDN and the destination port number,

a list of IP address resolved by inquiring of the DNS server with the newly created FQDN as a key is defined as a candidate content server for delivering the content to the client, and

the content server for delivering the content to the client is determined from the candidate.

In another preferred construction, the FQDN is resolved by inquiring of the DNS server with the destination IP address as a key,

a list of IP-address resolved by inquiring of the DNS server with the resolved FQDN as a key is defined as a candidate content server for delivering the content to the client, and

the content server for delivering the content to the client is determined from the candidate.

In another preferred construction, the server load balancing device further comprises packet receiving means for receiving a packet for requesting a content delivery, from the client, and packet transferring means for rewriting the destination IP address of the packet received by the packet receiving means into the IP address of the content server for delivering the requested content to the client and transferring the same to the content server.

In another preferred construction, the packet transferring means resolves a MAC address corresponding to the IP address of the content server for delivering the requested content to the client, and transferring the packet to the content server, after rewriting the destination MAC of the packet for requesting the content delivery, received by the packet receiving means, into the resolved MAC address.

According to the third aspect of the invention, a content server for delivering content, comprises means for notifying a calibrated value of an actual resource value calculated as resource information, of a node for selecting a delivery destination of the content based on the resource information about each server.

According to another aspect of the invention, a content management device for managing content delivered by a content server, comprises content classification means for classifying the content which the content server delivers, into a plurality of groups, according to characteristic of the content, and content grouping means for collecting together the content classified into the groups, in every group.

In the preferred construction, the content classification means classifies the content by the characteristics.

In another preferred construction, the content classification means gradually classifies the content step by step, according to a hierarchical structure of gradually fining granularity of classification of the characteristics of the content.

In another preferred construction, the content grouping means collects together the content classified into the same group, under a same directory.

According to another aspect of the invention, a server load balancing program for distributing a content delivery to a client among a plurality of content servers, by controlling a computer, comprises a function of referring to selection criteria of the content server with correspondence between characteristics of the content and resource information about the content servers, and a function of determining the content server for delivering the content requested from the client, based on the selection criteria, according to the resource information and the characteristic of the requested content.

According to a further aspect of the invention, a content delivery management program for managing a content delivery of a content server for delivering content, by controlling a computer, comprises a function of notifying a calibrated value of an actual resource value calculated as usable resource information at this point, to a node for selecting a delivery destination of the content according to the resources of the servers.

According to a still further aspect of the invention, a content management program for managing content which a content server delivers, by controlling a computer, comprises a content classification function for classifying the content which the content server delivers into a plurality of groups, according to the characteristics of the content, and a content grouping function for collecting together the content classified into the groups, in every group.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing the structure of a first embodiment of the present invention;

FIG. 2 is a view showing an example of a classification policy set by a classification policy setting unit, according to the first embodiment of the present invention;

FIG. 3 is a view showing an example of URL rewriting processing performed by a content grouping unit, according to the first embodiment of the present invention;

FIG. 4 is a flow chart showing the operation of a content management device, according to the first embodiment of the present invention;

FIG. 5 is a view showing an example in the case of realizing the content management device of the first embodiment of the present invention as the function of a part of a content server;

FIG. 6 is a view showing an example of connecting a plurality of content servers to the content management device of the first embodiment of the present invention;

FIG. 7 is a block diagram showing the structure of a second embodiment of the present invention;

FIG. 8 is a view showing an example of a policy for determining a destination server set by a destination server determining policy setting unit, according to the second embodiment of the present invention;

FIG. 9 is a view showing an example of entry registered in a request routing table, according to the second embodiment of the present invention;

FIG. 10 is a flow chart showing the operation of receiving a request from a client in a server load balancing device, according to the second embodiment of the present invention;

FIG. 11 is a flow chart showing the operation of determining a destination server in a destination server determining unit of the server load balancing device, according to the second embodiment of the present invention;

FIG. 12 is a flow chart showing the operation of managing the entries registered in the request routing table in the server load balancing device, according to the second embodiment of the present invention;

FIG. 13 is a block diagram showing the structure of a third embodiment of the present invention;

FIG. 14 is a view showing an example of a resource response policy set by a resource response policy setting unit, according to the third embodiment of the present invention;

FIG. 15 is a flow chart showing the operation of receiving a request for obtaining resource from the server load balancing device in a content server, according to the third embodiment of the present invention;

FIG. 16 is a block diagram showing the structure of a fourth embodiment of the present invention;

FIG. 17 is a view showing an example of entry registered in a request routing table, according to the fourth embodiment of the present invention;

FIG. 18 is a flow chart showing the operation of the server load balancing device, according to the fourth embodiment of the present invention;

FIG. 19 is another flow chart showing the operation of the server load balancing device, according to the fourth embodiment of the present invention;

FIG. 20 is a block diagram showing the structure of a fifth embodiment of the present invention;

FIG. 21 is a view showing an example of entry registered in a packet routing table, according to the fifth embodiment of the present invention;

FIG. 22 is a view showing an example of entry registered in an address/FQDN resolution table, according to the fifth embodiment of the present invention;

FIG. 23 is a flow chart showing the operation when a client sends a request for obtaining content, according to the fifth embodiment of the present invention;

FIG. 24 is a flow chart showing the operation of receiving a packet from a client in the server load balancing device, according to the fifth embodiment of the present invention;

FIG. 25 is a flow chart showing the operation of creating an entry in a packet routing table, according to the fifth embodiment of the present invention;

FIG. 26 is a view of network structure, according to the second embodiment of the present invention;

FIG. 27 is a view of network structure, according to the third embodiment of the present invention;

FIG. 28 is a view showing an example of the request routing table, according to the third embodiment; and

FIG. 29 is a view showing an example in the case of creating the entry of a destination server in the request routing table, according to the fourth embodiment.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

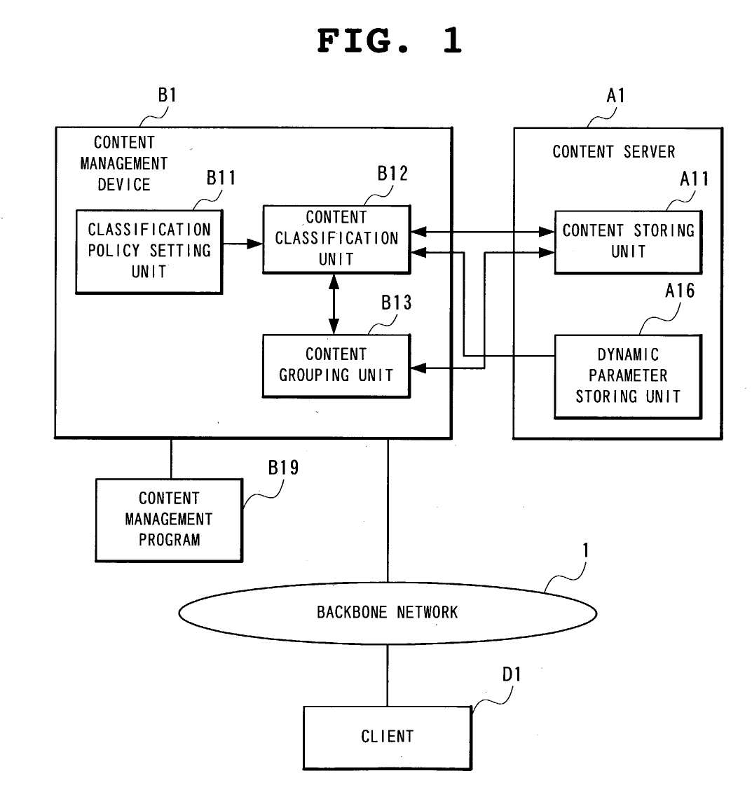

Referring to FIG. 1, the first embodiment of the present invention is realized by a content server A1 and a content management device B1. A client D1 getting access to the content on the content server A1 is connected to the content management device B1 through a backbone 1.

The content server A1 includes a content storing unit A11 and a dynamic parameter storing unit A16. The content storing unit A11 stores the delivery content itself such as the WWW content and the streaming content, a program accompanying the content, a database necessary for program execution, and the like. Each content is identified according to an identifier on the side of a client, and for example, in HTTP (Hyper Text Transfer Protocol), each content is identified by the URL (Universal Resource Locator). The dynamic parameter storing unit A16 stores the dynamic parameters (resource information) as the dynamic characteristics such as access frequency and CPU load for every deliver content, which parameters are referred to by the content management device B1. The contents of the dynamic parameters are sequentially updated by the content server A1. Hereinafter, the resource value does not have to be the numeric value indicating the access frequency or the CPU load concretely but it may be the information indicating the degree of the above.

The content management device B1 includes a classification policy setting unit B11, a content classification unit B12, and a content grouping unit B13. The classification policy setting unit B11 sets a classification policy for grouping the content included in the content storing unit A11, according to the characteristics thereof (the static characteristics such as the type and the size of the content and the dynamic characteristics such as access frequency).

Here, a classification policy contains the information for roughly classifying various content such as file, stream, and CGI (Common Gateway Interface) into every type of media. Further, it may contain the information for further classifying the classified information of each type in more detail. It may be a policy for classifying, for example, a file into large, middle, and small according to its size, or a policy for classifying stream into high, middle, and low according to its transfer rate. Alternatively, it may be a policy based on the dynamic characteristic for classifying the access frequency into high, middle, and low.

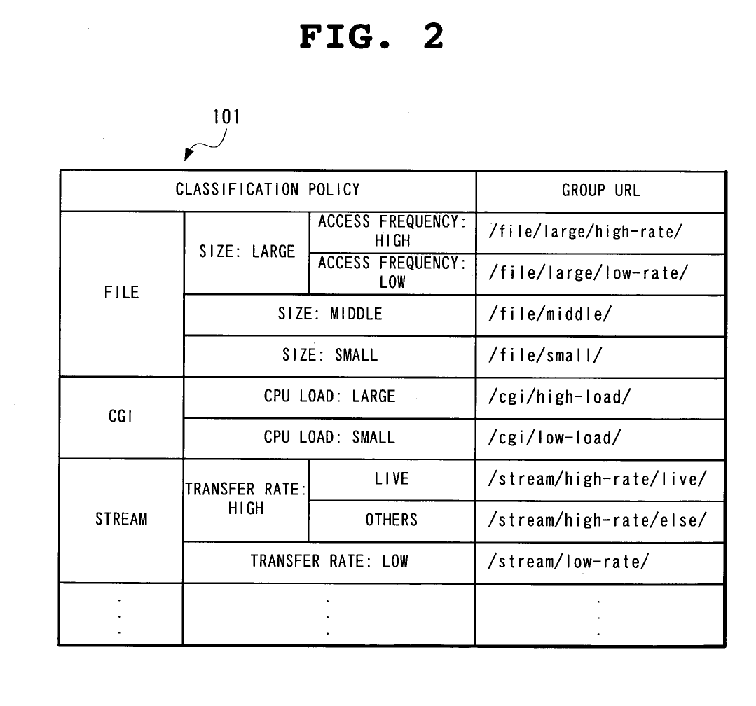

FIG. 2 is an example of a classification policy table 101 showing a classification policy set within the classification policy setting unit B11. For example, the content classified into a file is classified into three groups of large, middle, and small by its size, and the group classified into the large size is further classified into two groups of high and low according to its access frequency. Further, the table shows each URL where each content group classified according to the set policy is grouped together.

The content classification unit B12 classifies each content within the content storing unit A11 according to the classification policy set by the classification policy setting unit B11. In this classification, the static parameter such as the type and the size that can be obtained from the content itself and the dynamic parameter such as the access frequency stored in the dynamic parameter storing unit A16 are referred to. For example, the content is classified into every type of media such as file, stream, and CGI. When the further detailed classification policy is set for every type of media, the content is classified into a plurality of content groups depending on, for example, the file size and the access frequency, according to the policy.

The content grouping unit B13 groups the content in every content group, according to the result of the automatic classification of the content by the content classification unit B12. When the case of the URL is taken as an example, the URL is represented by using a directory where the content is located within the content storing unit A11. However, each content within the content group created by the content classification unit B12 is not always grouped together under the same directory, but it is difficult for the client D1 to identify which content belongs to which content group. Accordingly, rewriting processing of the URL is performed so as to arrange the content within the same content group under the same directory.

In one example of the classification policy table 101 shown in FIG. 2, each URL where each classified content group should be grouped together is shown, and for example, all the content which is classified into the CGI and the high load on CPU is moved under the directory of “/cgi/high-load/”.

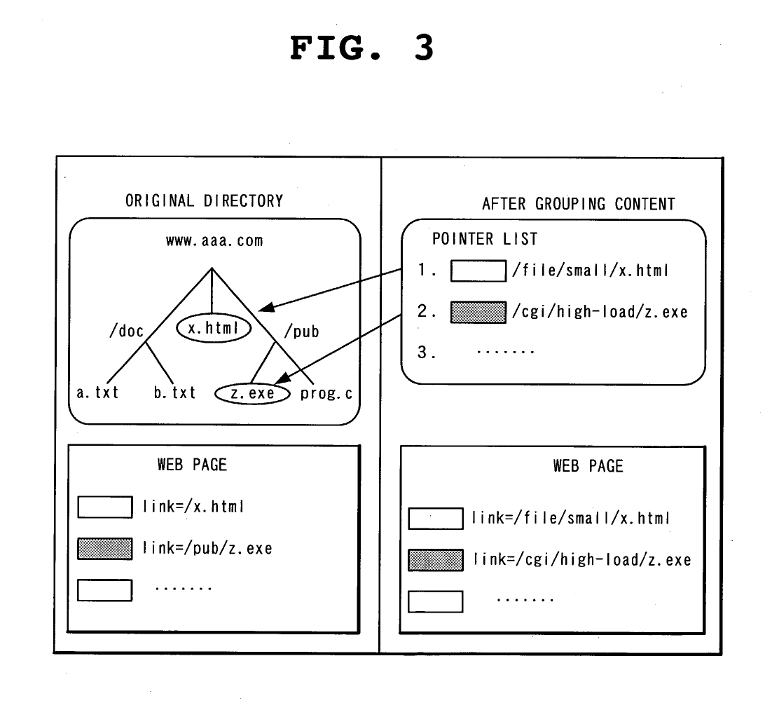

FIG. 3 is a view for use in describing the URL rewriting processing concretely. For example, assume that the content whose original directory path is “/pub/z.exe” should be grouped together under the directory of “/cgi/high-load”, after classification according to the set policy. The content having the directory path of “/cgi/high-load/z.exe” is created as a symbolic link toward “/pub/z.exe”. Further, all the reference links within the web page referring to “/pub/z.exe” are rewritten to the directory path after grouping.

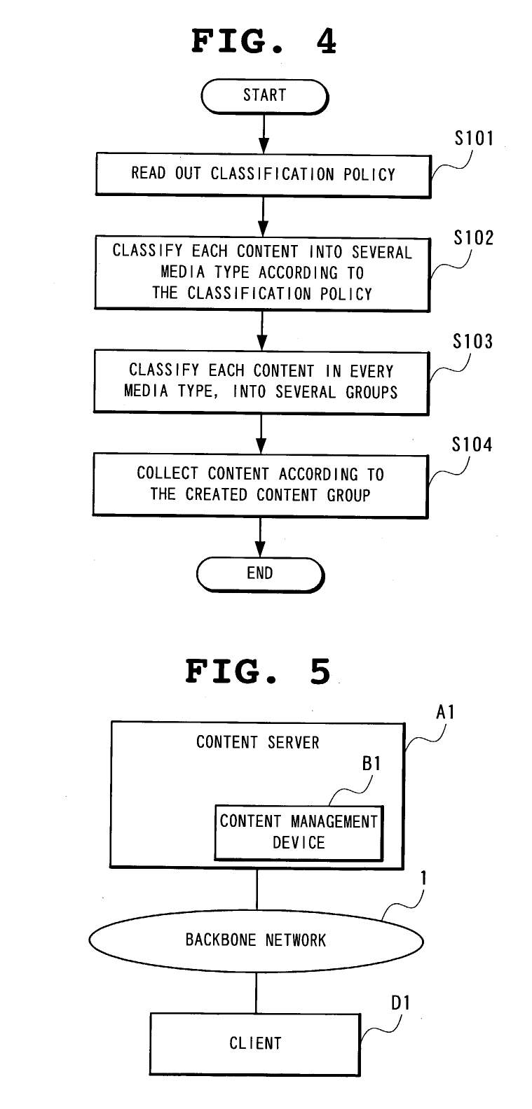

Next, with reference to FIG. 4, the operation of automatic grouping depending on the characteristic of the content in the content management device B1 will be described in detail, in this embodiment.

In the content management device B1, the content classification unit B12 reads out the classification policy of the content set within the classification policy setting unit B11 (Step S101 in FIG. 4), and the content within the content storing unit A11 is classified into several media types according to the read out classification policy (Step S102).

When finishing the classification of the content into the several media types, the content classification unit B12 further classifies the content having been classified into each media type, into a plurality of content groups (Step S103). This step is to classify the content depending on the detailed characteristics such as the size and the access frequency, referring to the dynamic parameters such as the access frequency stored in the dynamic parameter storing unit A16.

When finishing the classification into the media types and the classification into the content groups in every media type, the content grouping unit B13 groups the content into every content group (Step S104).

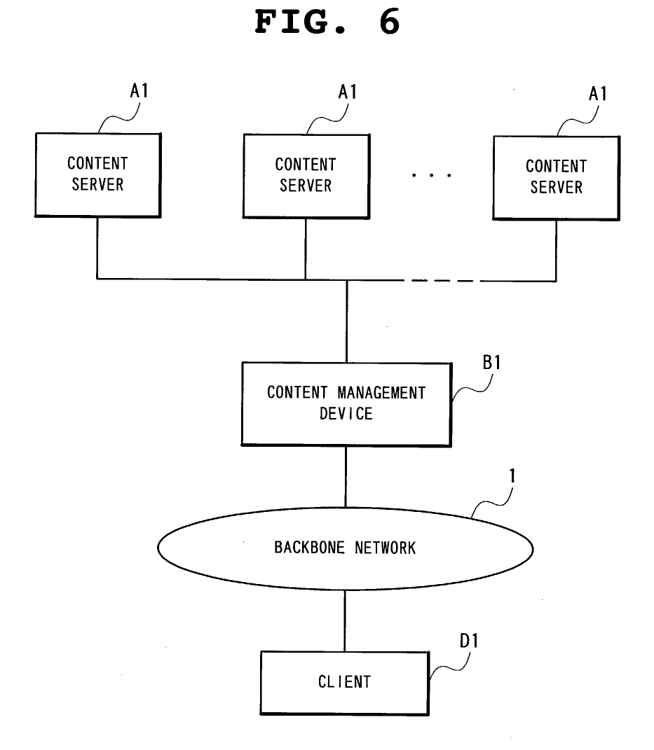

In the embodiment, although the content management device B1 has been described as the unit realized within the independent node here, it can be realized as one function of the content server A1 as illustrated in FIG. 5. Further, it may be realized on some node including the server load balancing device C1 described in the second embodiment and it may be realized as one function of a gateway.

Further, although the case of connecting one content server A1 to the content management device B1 has been described in the above description, a plurality of content servers A1 may be connected to the content management device B1, as illustrated in FIG. 6, and the content management device B1 may classify the content in every content server A1, hence to manage the content.

The effects of the embodiment will be described. In this embodiment, the content management device B1 automatically classifies the content within the content server depending on their characteristics. A feature of this embodiment is that the classification can be also performed depending on the dynamic characteristic.

Further, the content groups created as a result of the classification are automatically grouped. The content within the content server is not initially grouped into every characteristic under the same directory. For example, the content having various characteristics from the viewpoint of the file size and the media type, such as article, picture, and video of the news, are generally located under the directory “/news/” about the news, in a mixed way.

This embodiment can reconstruct each content group having the same characteristic under the same directory, and when the server load balancing device, described later, on the side of a client selects the optimum server in every directory, the most suitable request routing to the characteristic of the content can be realized with the minimum number of entries.

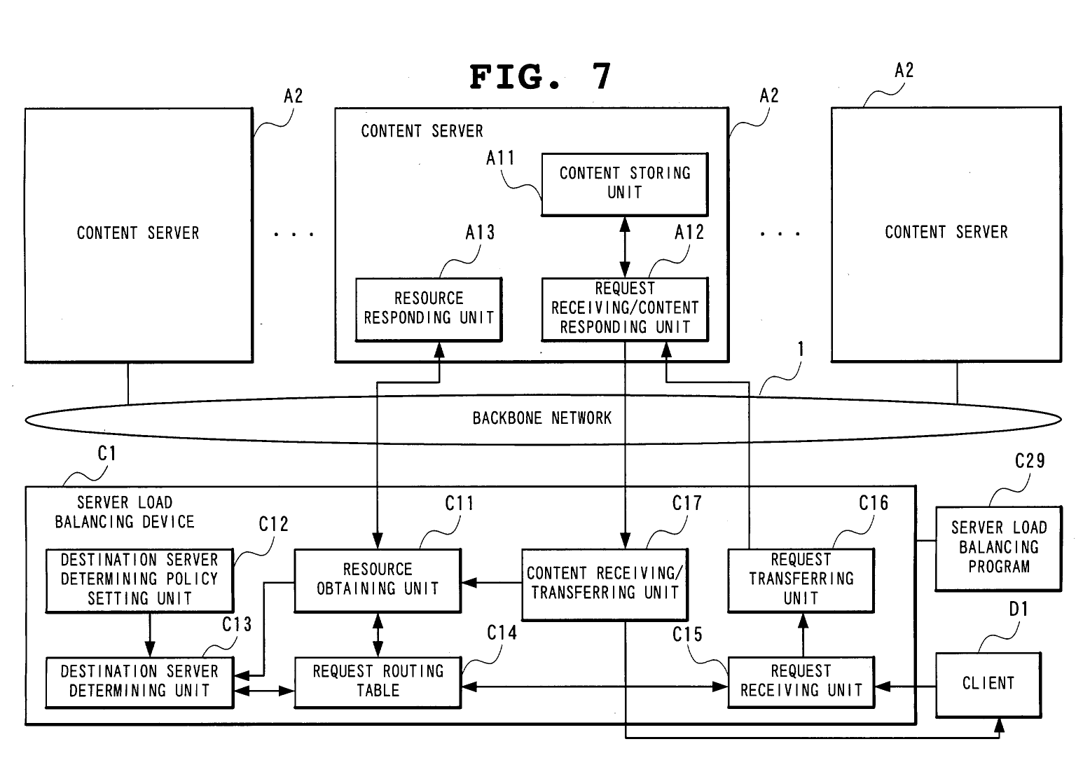

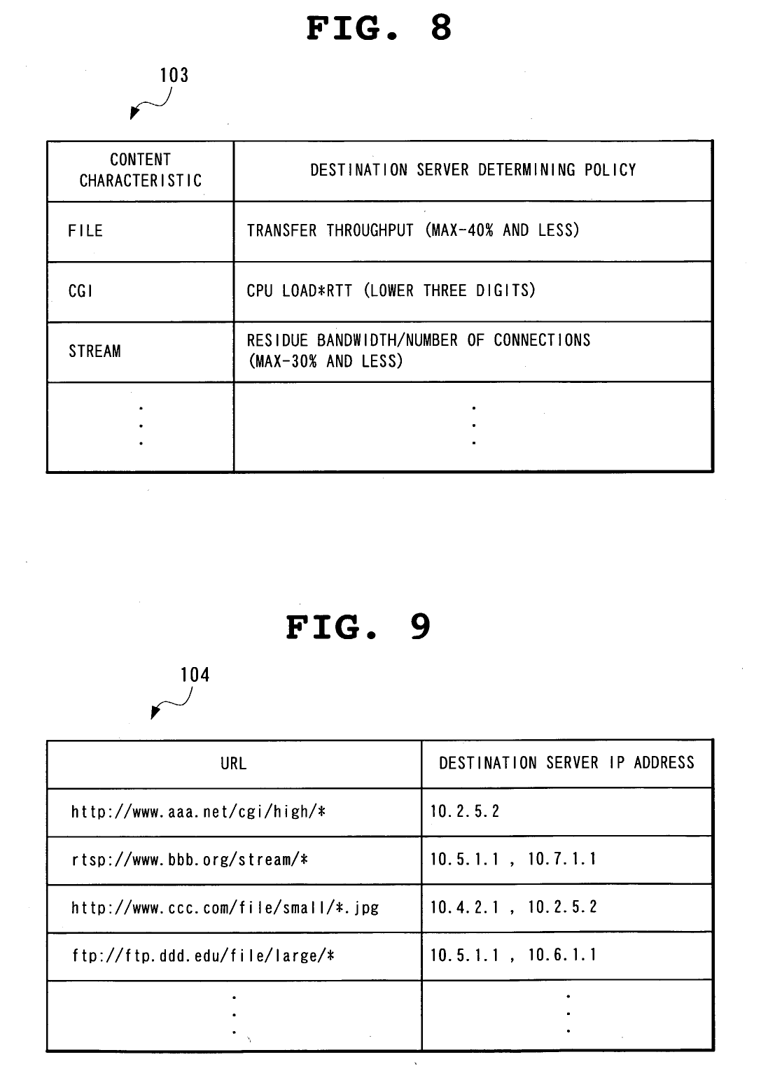

Next, a second embodiment of the present invention will be described in detail with reference to the drawings. Referring to FIG. 7, the second embodiment of the present invention can be realized by a content server A2, a server load balancing device C1, and the client D1.

The content server A2 includes the content storing unit A11 for storing various delivery content, a request receiving/content responding unit A12, and a resource responding unit A13.

The request receiving/content responding unit A12 receives a request from the client D1 and identifies the corresponding content in reply. Then, it sends the above content to the client D1.

The resource responding unit A13 replies to a request for obtaining the resource information from the server load balancing device C1 and returns the resource parameters such as server load, the number of connections, and the link using rate, depending on the contents of the request. When the server load balancing device C1 does not request the content server A2 to obtain the resource information, the resource responding unit A13 can be omitted.

The sever load balancing device C1 includes a resource obtaining unit C11, a destination server determining policy setting unit C12, a destination server determining unit C13, a request routing table C14, a request receiving unit C15, a request transferring unit C16, and a content receiving/transferring unit C17. The server load balancing device C1 can be realized, for example, as one function of a proxy server which intensively manages a plurality of requests from a client.

When any resource information about a content server is not registered in the request routing table C14, for example, as a destination server and the other candidate server, the resource obtaining unit C11 obtains the resource information necessary for registering a destination server, or it obtains the resource information about the destination server and the other candidate server registered in the request routing table C14. The resource information includes, for example, resource parameters within a network such as RTT (Round Trip Time) to a Web server and transfer throughput, and resource parameters about a server itself such as the load of a Web server and the number of connections. There are roughly two methods of obtaining the resource information.

One is a method for requesting the information such as the CPU load and the residue bandwidth to the self-node from the content server A2 so as to obtain the information (active type), and another is a method for obtaining a delay taken for the transfer of the received content and the obtained transfer throughput, from the content receiving/transferring unit C17 (passive type). By use of the passive type method, it is possible to indirectly predict the CPU load of a server and the number of sessions.

Further, it is possible to predict or extract another resource parameter from the obtained resource parameter. For example, the following methods can be considered; (1) regarding the measured time for obtaining the small-sized content, as RTT, and (2) regarding the time for obtaining the CGI content having a large load at a program run, as the server load.

The destination server determining policy setting unit C12 sets a destination server determining policy table 103 indicating each policy for selecting a destination server depending on the characteristic of each content.

FIG. 8 shows an example of the destination server determining policy table 103 indicating each policy set within the destination server determining policy setting unit C12. In the destination server determining policy table 103, as for the content group having the file characteristic, the transfer throughput at a time of obtaining the content is used, a server having the maximum transfer throughput is regarded as a reference, and a server having the value of 60% and more of the above maximum is selected as a destination server. As for the content group having the CGI characteristic, the value obtained by multiplying the CPU load by the RTT to a sever is used, three servers are selected in the increasing order of this value.

The destination server determining unit C13 determines a destination server, by using the resource parameter set in the destination server determining policy setting unit C12, from the resource parameters obtained by the resource obtaining unit C11.

The request routing table C14 is a table indicating which server to transfer a request received by the request receiving unit C15. The entries within the table are written by the destination server determining unit C13.

FIG. 9 is a table 104 indicating one example of the request routing table C14. In this table 104, IP addresses of the destination servers corresponding to the URLs of each content to be requested are written.

For example, the entry of the URL “http://www.aaa.net/cgi/high/*” is the URL prefix expression, indicating all the URLs having the head portion of “http://www.aaa.net/cgi/high/”. A request corresponding to this entry is transferred to the content server having the IP address of “10.2.5.2”. The entry of the URL “http://www.ccc.com/file/small/*.jpg” means the content having jpg as the file extension, out of all the content under “http://www.ccc.com/file/small/”. A request corresponding to the entry is transferred to the content server having the IP address of “10.4.2.1” or the content server having the IP address of “10.2.5.2”.

When the several destination server IP addresses are specified thus, one server can be selected for every request in a round robin method or it can be selected depending on the weight specified for every server, namely the priority ratio, by using the weighted round robin or weighted hash function.

The request receiving unit C15 receives a request from the client D1 and analyzes the contents thereof. By analyzing the contents of the request, it identifies the URL of the content requested by the client D1. Further, it determines a destination server to transfer the request, by reference to the request routing table C14, and hands it to the request transferring unit C16.

Upon receipt of the contents of the transfer request and the transfer server information from the request receiving unit C15, the request transferring unit C16 transfers the request to the content server A2.

The content receiving/transferring unit C17 receives the reply content from the content server A2 corresponding to the request sent by the request transferring unit C16 and transfers the above content to the client D1.

The client D1 is to issue a request for obtaining the content within the content server A2. The request is led to the content server A2 specified by the server load balancing device. Here, the client D1 includes not only one client but also a plurality of clients.

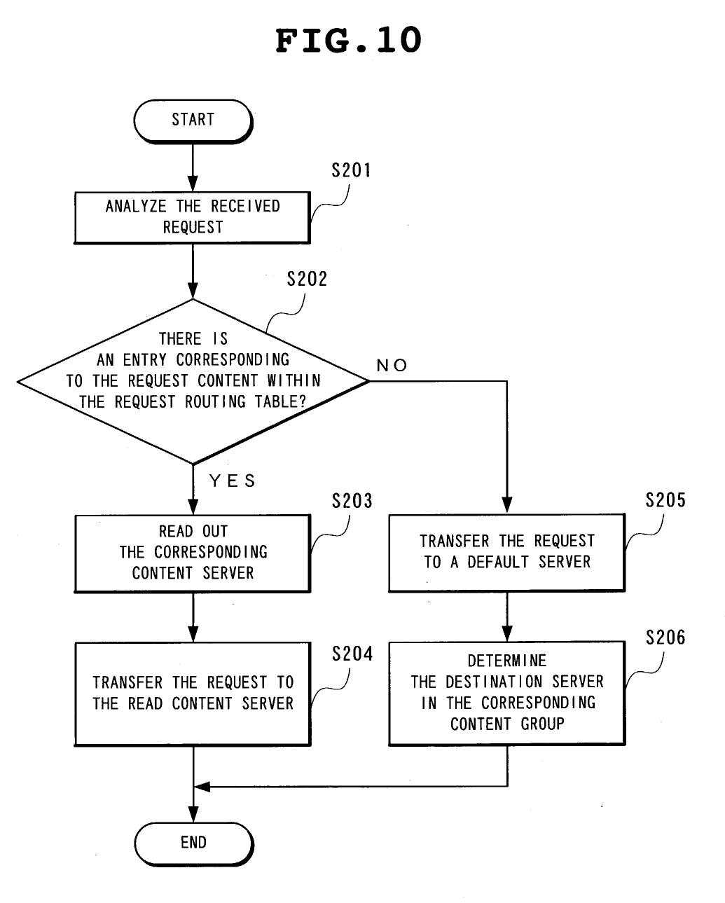

The operation of selecting a destination server while changing a selection policy according to the characteristic of each content in the server load balancing device C1, in the embodiment, will be described in detail with reference to FIG. 10 to FIG. 12.

First, the operation when the server load balancing device C1 receives a request for obtaining the content, from the client D1, will be described by using FIG. 10.

When the request receiving unit C15 receives the request from the client D1 in the server load balancing device C1, it analyzes the request and identifies the URL of the requested content (Step S201 in FIG. 10).

The request receiving unit C15 checks whether there is the entry corresponding to the identifier of the requested content, within the request routing table 104 (Step S202).

In Step S202, when there is the entry corresponding to the above content, the request receiving unit C15 reads out the content server A2 of the destination of transferring a request, referring to the entry (Step S203). The request transferring unit C16 receives the request to be transferred and the information of the content server A2 to be transferred, from the request receiving unit C15 and transfers the request to the content server A2 (Step S204).

In Step S202, when there is no entry corresponding to the content, the request receiving unit C15 transfers the request to a default server (Step S205), determines a destination server for the content group including the requested content, and writes the entry of the destination server into the request routing table (Step S206). Here, the default server means a server corresponding to the destination IP address of the IP packet including the request as the data and a server corresponding to the IP address resolved by using the Domain Name System server (DNS server), out of the FQDN (Fully Qualified Domain Name) portion of the URL within the request.

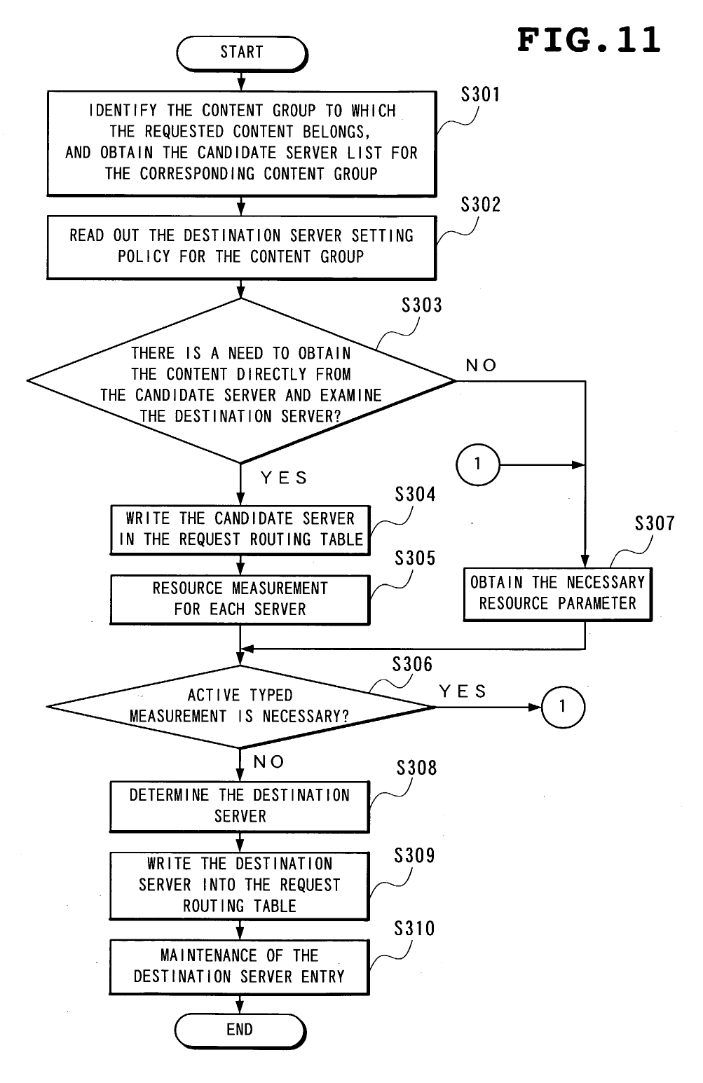

A flow chart for use in describing the operation corresponding to the above Step S206 in detail is FIG. 11.

The destination server determining unit C13 identifies which content group the requested content belongs to and obtains a candidate server list corresponding to the content group (Step S301 in FIG. 11). As the identifying/obtaining method in this step, there are a method of inquiring of the content management device B1 with the whole or one portion of the URL within the request as a key and a method of directly inquiring of the content server A2. Here, a candidate server means all the content servers A2 holding the content group or a server group resulting from extracting one from all the content servers A2 holding the content group.

Further, there is a method of identifying the content group corresponding to the URL and obtaining a candidate server list by using the DNS server. In this case, each unique FQDN for every content group is required and a content server corresponding to each IP address resolved with the FQDN as a key is regarded as a candidate server. As an example of the creating method of the unique FQDN for every content group, when the URL corresponding to the requested content is “http://www.aaa.net/cgi/high/prog.cgi”, the “high.cgi.www.aaa.net” is defined as the FQDN corresponding to the content group including the content, and the IP address of a candidate server is resolved with the FQDN as a key.

The destination server determining unit C13 identifies which policy of the destination server determining policy setting unit C12 the content group follows and reads out the corresponding destination server determining policy (Step S302). As the identification method of the correspondence, there are the following two methods, by way of example.

(1) In inquiring of the content management device B1 in Step S301, the information of the content characteristic of the content group is obtained together.

(2) A table with each content characteristic corresponding to each URL and each destination port number mapped there is prepared in the server load balancing device C1 (for example, the content characteristic of the content group including cgi-bin in its URL is CGI and the content characteristic of the content group having the destination port number 554 is the stream.)

The destination server determining unit C13 obtains the resource by directly obtaining the content from a candidate server, namely checks whether the passive typed resource measurement is necessary or not (Step S303), in order to determine the destination server corresponding to the content group, according to the destination server determining policy read out in Step S302.

As an example of the case where the passive typed resource measurement is necessary, there is the case of using the resource parameter such as the transfer delay and the transfer throughput of the content for determining a destination server. On the contrary, as an example of the case where the passive typed resource measurement is not necessary, there is the case of obtaining the resource parameter such as the server load and the link bandwidth through the inquiry and performing the active typed resource measurement for use in destination server determination by using the result. Alternatively, a destination server may be determined by the passive typed resource measurement and the active typed resource measurement in a mixed way.

In Step S303, when it is necessary to examine a destination server through the passive typed resource measurement, the destination server determining unit C13 writes the candidate servers into the request routing table C14 (Step S304).

When the candidate servers are written into the request routing table C14 in Step S304, the request routing table C14 selects one content server out of the candidate servers as the destination of the request for the content belonging to the content group.

Here, it is configured that the request is transferred to all the candidate servers by selecting the destination in the round robin method. By distributing the request to each candidate server, the content receiving/transferring unit C17 can receive the content from each candidate server and the resource obtaining unit C11 can know the resource parameter such as the transfer delay and the transfer throughput at that time (by measuring the receiving amount of the content per unit hour) (Step S305).

Whether the active typed resource measurement is necessary or not is checked (Step S306). Namely, when only the passive typed resource measurement in Step 305 cannot obtain the enough resource parameters, the active typed resource measurement is required and performed in Step 307.

When it is not necessary to examine a destination server through the passive typed resource measurement in Step S303, when it is judged that the active typed resource measurement is necessary, in Step 306, the destination server determining unit C13 measures and obtains the necessary resource parameter by using the resource obtaining unit C11 (Step S307).

When the resource parameter necessary for destination server determination is obtained in Step S305 or Step S307, the destination server determining unit C13 determines a destination server (Step S308), by using the above resource parameter and the destination server determining policy read in Step S301. At this time, a plurality of content servers may be determined as a destination server.

The entry of the determined destination server is written into the request routing table C14 as the request destination corresponding to the content group (Step S309). When writing a plurality of entries, the ratio and the weight of transferring the request to the respective content servers may be written at the same time.

When writing the destination server in the request routing table C14 in Step S309, this step moves to a state of maintaining the written entry (step S310).

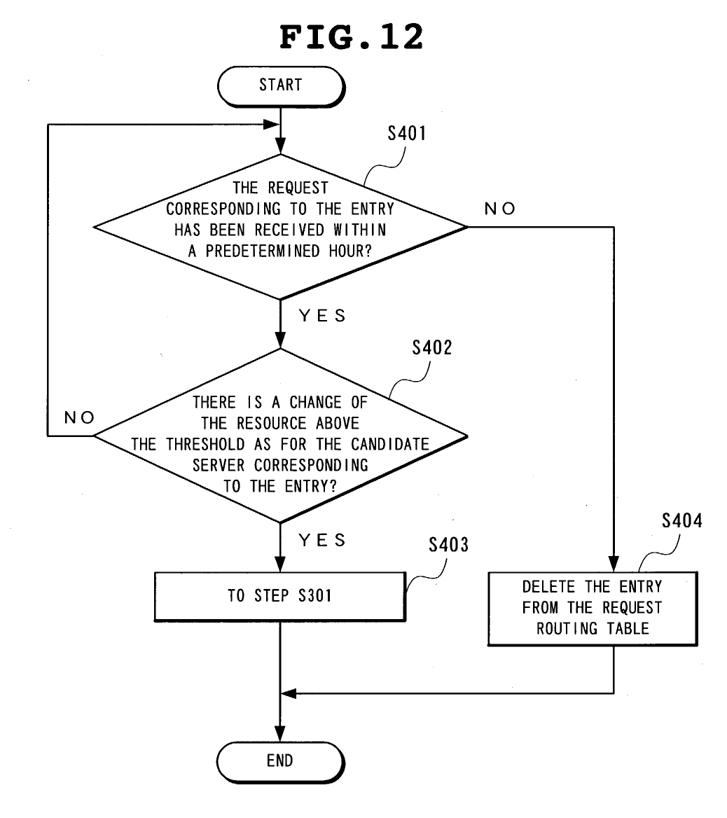

A flow chart for use in describing the operation corresponding to Step S310 in detail is FIG. 12.

The request routing table C14 periodically checks whether it has received a request corresponding to the destination server entry to be maintained within a predetermined hour (Step S401 in FIG. 12). If it has received no request for the predetermined hour and more, the corresponding entry is deleted (Step S404).

When receiving a request for the entry within the predetermined hour, it is checked as for the candidate server corresponding to the entry whether the resource value at a time of determining a destination is changed more than a predetermined threshold, by using the resource obtaining unit C11 (Step S402). This check is to examine whether the destination server determined in Step S307 is still suitable or not. When there is no variation beyond the threshold, this step is returned to Step S401 again.

In Step S402, when there is a variation beyond the threshold, it is returned to Step S301, where the operation for determining a destination server is performed again (Step S403).

The effects of the embodiment will be described.

In the embodiment, the server load balancing device determines a destination server according to each policy different for every content group and registers it into the request routing table. Hitherto, since a destination server has been selected for every content group according to the same reference, the optimum server could not be selected necessarily depending on each content group. In the embodiment, however, since the selection criteria of a destination server are changed depending on the characteristic of each content group, a request from a client is always transferred to the optimum server. Especially, by combining this embodiment with the first embodiment of automatically creating the content groups depending on the characteristic of the content, a server can be more effectively selected.

A third embodiment of the invention will be described in detail with reference to the drawings.

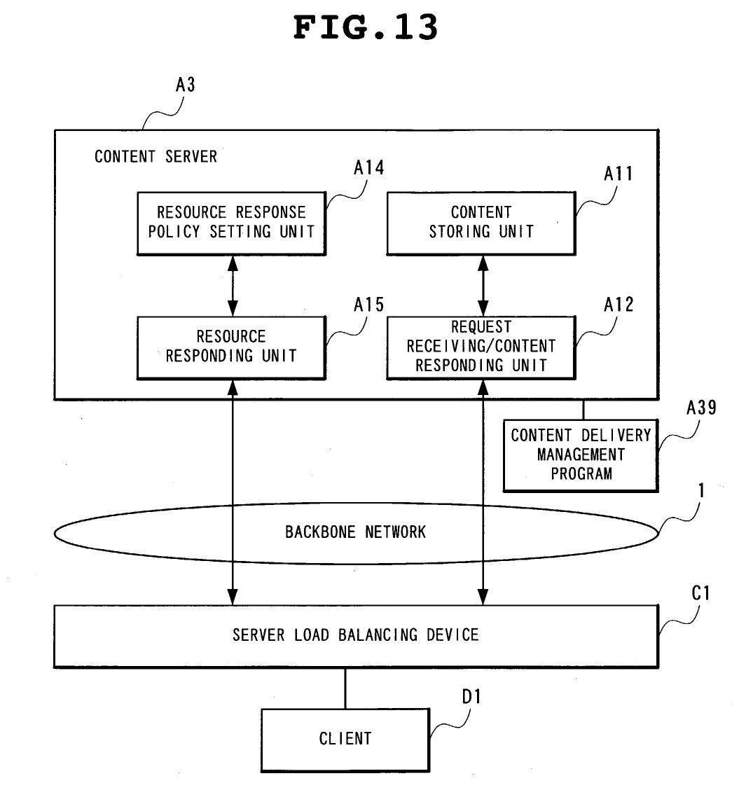

Referring to FIG. 13, the third embodiment of the present invention is realized by a content server A3 and the server load balancing device C1.

The content server A3 includes a resource response policy setting unit A14, in addition to the structure of the content server A2 of the second embodiment, and of the resource responding unit A13 is replaced with a resource responding unit A15. The other components are the same as those of the second embodiment shown in FIG. 7.

The resource response policy setting unit A14 is to set a policy for responding to a request for obtaining the resource information received from the server load balancing device C1. Here, the policy is used not to concentrate excessive access on the self-content server. For example, when the content server A3 is in a state where the CPU load of the self-node is low 10%, assume that it receives the requests for resource information acquisition from a plurality of server load balancing devices. At this time, when it returns the value of the CPU load 10% to all the server load balancing devices, the respective server load balancing devices, upon receipt of this value, judge that the CPU load of the content server A3 is enough low and they may select the content server A3 as a destination server to transfer the respective requests. As a result, the CPU load of the content server A3 may be rapidly increased by access concentration and it cannot provide the sufficient performance as the server. In the worst case, oscillatory phenomenon of recursively repeating the same operation may occur, such that all the server load balancing devices having selected the content server A3 as the destination server detect the deterioration of the server performance, select another content server as the destination server again, and that as a result, the newly selected content server will be again deteriorated in the performance by access concentration.

There is set a policy for preventing the above access concentration on a specified content server and the oscillatory phenomenon. As an example of the policy, there can be considered a policy of not returning the resource of a predetermined threshold and the above within a predetermined hour, or a policy of restraining the number of the server load balancing devices within a predetermined threshold, which devices can return the resource above a given value at the same time.

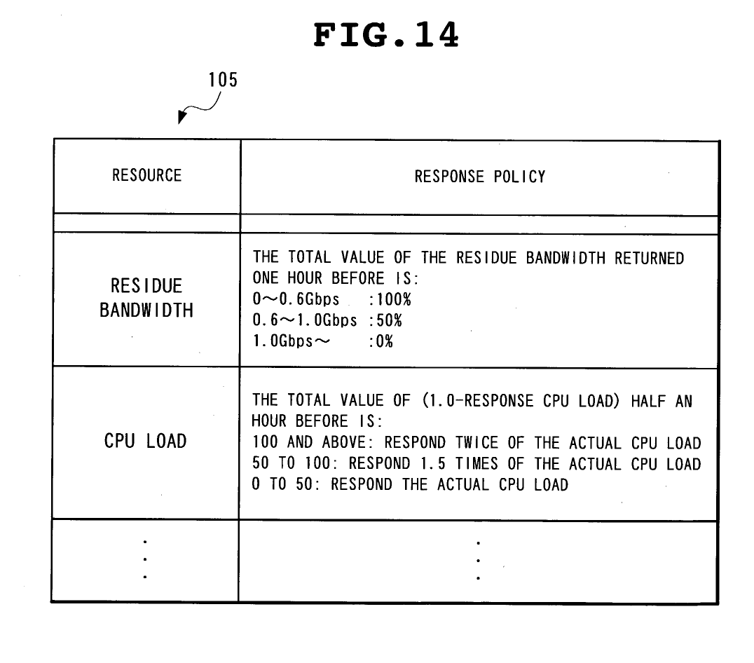

FIG. 14 is an example of the resource response policy table 105 indicating each policy set within the resource response policy setting unit A14. Each response policy depending on each type of resource is shown in the resource response policy table 105. For example, as for the CPU load, when the current CPU load is 0% to 30%, the twice value of the actual CPU load is returned with the probability of 30% (the actual value is returned with the probability of 70%), when it is 30% to 60%, the one and half times of the actual CPU load is returned with the probability of 50%, and when it is 60% to 100%, the actual value is returned.

The resource responding unit A15 returns the resource parameter in reply to the request for obtaining the resource information from the server load balancing device C1, in the same way as the resource responding unit A13 in the first embodiment. However, at a return of the resource, the resource responding unit A15 refers to the policy at that time set within the resource response policy setting unit A14 and calculates the resource value to be returned according to the above policy.

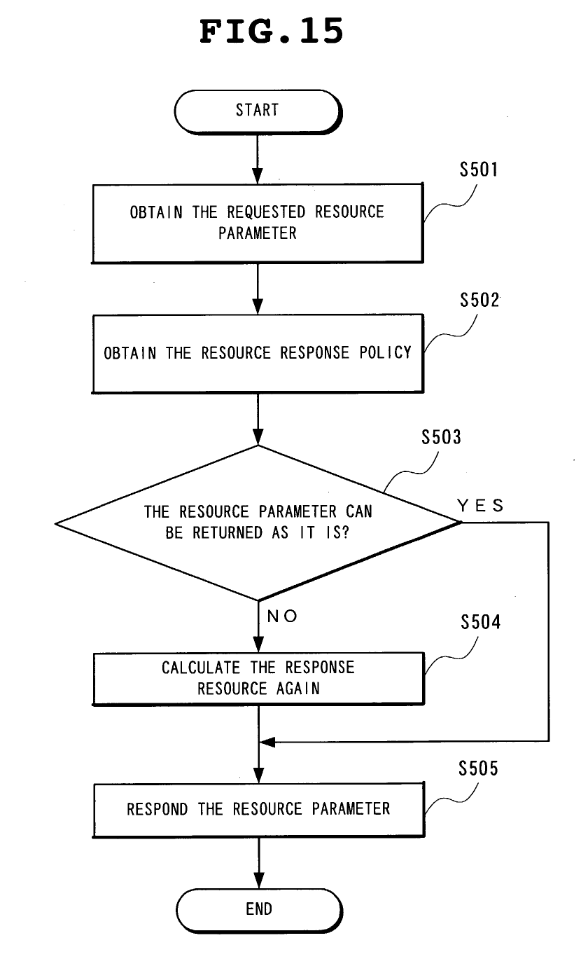

Referring to FIG. 15, the operation of receiving a request for obtaining resource from the server load balancing device C1 in the content server A3 will be described in detail.

Upon receipt of the request for obtaining resource information from the server load balancing device C1, the resource responding unit A15 within the content server A3 obtains the resource value corresponding to the requested resource parameter in the self-node (Step S501 in FIG. 15).

The resource responding unit A15 obtains the resource response policy corresponding to the resource parameter from the resource response policy setting unit A14 (Step S502).

After Step S502, the resource responding unit A15 checks whether or not it can respond the resource parameter obtained in Step S501 as it is (Step S503).

When judging that the resource parameter can be returned as it is, in Step S503, the resource responding unit A15 returns the resource parameter to the server load balancing device C1 having issued the request for obtaining the resource information (Step S505).

When judging that the resource parameter cannot be returned as it is, in Step S503, the resource responding unit A15 calculates the resource value for return, according to the resource response policy corresponding to the resource parameter (Step S504). The calculated resource value is returned to the server load balancing device C1 having issued the request for obtaining the resource information, as the resource parameter (Step S505).

The effects of this embodiment will be described. In the embodiment, the content server does not always return the actual resource information as it is, but returns the resource value calibrated according to the set resource response policy, to the respective requests for obtaining the resource information from the several server load balancing devices disposed within a network.

Since each of the server load balancing devices determines a destination server individually, if the actual resource information is returned as it is like the conventional art, there is a possibility that a rapid concentration of requests may occur because a lot of server load balancing devices select this content server as a destination server simultaneously. The above rapid concentration of requests can be restrained by returning the resource value calibrated, like this embodiment.

A fourth embodiment of the present invention will be described in detail with reference to the drawings.

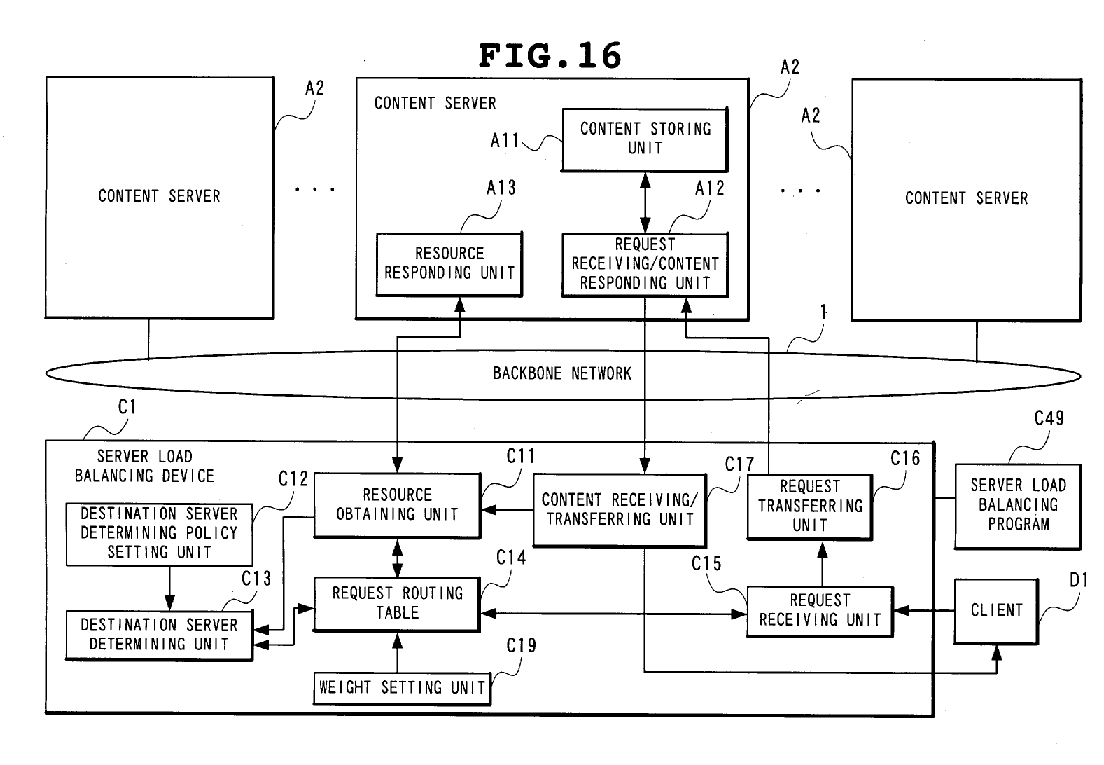

Referring to FIG. 16, the fourth embodiment of the present invention is realized by the content server A2 and a server load balancing device C2.

The server load balancing device C2 includes a weight setting unit C19, in addition to the structure of the server load balancing device C1 of the second embodiment. Further, the request routing table C14 is replaced with a request routing table C18.

The request routing table C18 has the same function as that of the request routing table C14 having been described in the second embodiment, but it is different in that a transfer weight value is attached to every destination server IP address in the respective entries. A server to be responded to the request receiving unit C15 is selected with the ratio of the weight value specified to every server, by using the waited round robin or the weighted hash function.

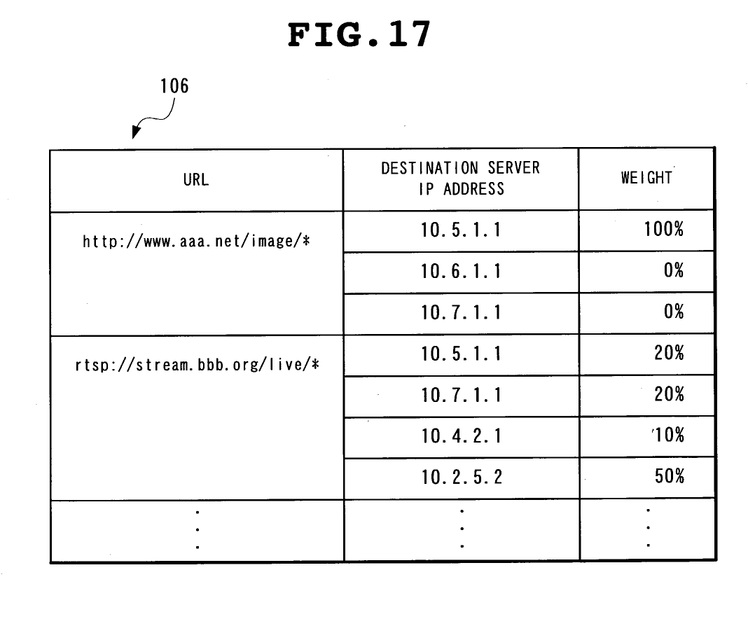

Although a server which does not transfer a request is not registered in the request routing table C14, all the candidate servers for the content group are registered in the request routing table C18. At this time, a server that will not transfer a request is registered with the weight 0%. FIG. 17 shows a table 106 by way of example of the request routing table C18.

The weight setting unit C19 has a function of setting/changing the transfer weight value within the request routing table C18. In the request routing table 106 in FIG. 17, the respective transfer server IP addresses “10.5.1.1”, “10.7.1.1”, “10.4.2.1”, and “10.2.5.2” as for “rtsp://stream.bbb.org/live/*” have the respective weight values 20%, 20%, 10%, and 50% and the weight setting unit C19 performs the operation of changing the above values respectively to 30%, 30%, 20%, and 20%, for example.

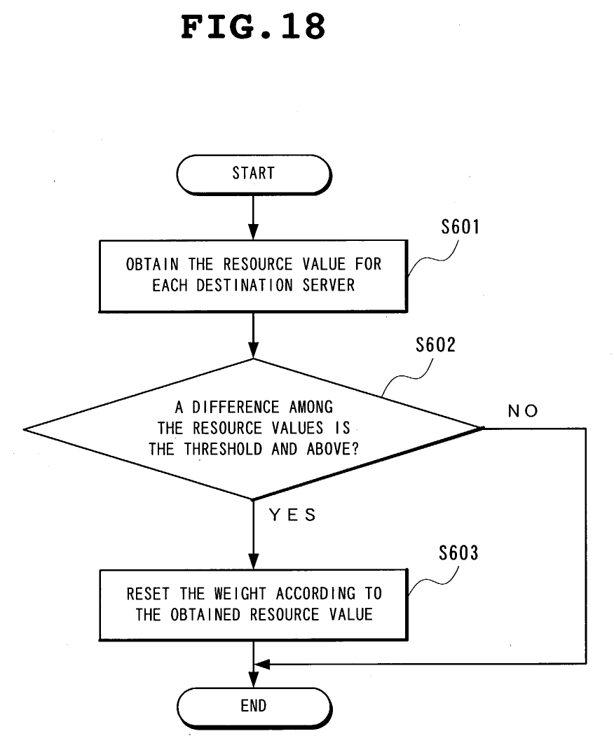

Referring to FIG. 18, the operation of preventing from the load concentration on a specific server in the server load balancing device C2 will be described in detail.

The destination server determining unit C13 obtains each resource corresponding to each destination server registered by using the resource obtaining unit C11, for every entry within the request routing table C18 (Step S601 in FIG. 18). The type of the obtained resource is set within the destination server determining policy setting unit C12 and it may be various in every entry.

When obtaining the resources corresponding to the respective destination servers, the destination server determining unit C13 makes a comparison among the obtained resources as for the respective servers and checks whether a difference in the resource values among the servers is beyond a predetermined threshold (Step S602). A reference of this check includes, by way of example, “the maximum value of the obtained resource values as for every server is twice larger than the minimum value, and the above” and “a difference between the maximum value and the minimum value of the obtained transfer throughputs as for every server is 1 Mbps and more”.

When a difference in the resource values among the servers is not beyond a predetermined threshold in Step S602, the weight value set in the request routing table C18 is not changed, while when it is beyond the above threshold, the weight setting unit C19 resets the weight value according to the obtained resource value (Step S603).

For example, assume that three destination servers; server A, server B, and server C are registered and that the respective weight values are 30%, 50%, and 20%. Assume that the obtained transfer throughputs as for the three servers are respectively 6 Mbps, 3 Mbps, and 1 Mbps. At this time, the weight values are changed to 60%, 30%, and 10% according to the ratio of the transfer throughput.

From the viewpoint of oscillation prevention, however, it is not preferable that the weight values are abruptly changed according to the ratio of the resource value. In the case of the above example, after changing the weight, although the request for the server A is increased from 30% to 60%, if the ratio of the request for the server A is increased similarly also in another server load balancing device, the number of the requests for the server A is rapidly increased and there is a possibility of extremely deteriorating the transfer throughput of the server A. Then, it is necessary to change the weight value again and there is a possibility that the weight changing operation may not converge but oscillate. In order to prevent from the oscillation, there is a method of restricting the rate of the weight change by using move_granularity, without abruptly changing the weight values according to the ratio of the resource value. The move_granularity is a parameter for restricting the first change of weight values and takes the value of 1.0 and less. In the above example, the case of changing the weight value as for the server A from 30% to 60% according to the ratio of the resource value, corresponds to “move_granularity=1.0”. For example, in the above example, in the case of “move_granularity=0.3”, the weight value is changed by only (60%−30%)×0.3=9%, as for the server A, and the changed weight value becomes 39%. Similarly, the changed weight values as for the server B and the server C become 44% and 17% respectively.

By gradually changing the weight value by using the move_granularity as mentioned above, it is possible to restrain a rapid increase/decrease in the number of the requests received by a specified server and prevent from oscillation. Here, it is important to set the value of the move_granularity not to cause an oscillation. For example, a method for automatically adjusting the move_granularity to a value free from oscillation, by using the feedback control, can be considered.

The destination server determining unit periodically executes the operation from Step S601 through S603 periodically, in every entry within the request routing table C18.

The operation having been described in FIG. 18 has to use the move_granularity and adjust its value so as not to cause an oscillation. This time, the operation in a method of restraining a rapid change in the number of the requests for a content server, without necessity of adjusting the move_granularity (namely, as it is “move_granularity=1.0”) will be described in detail.

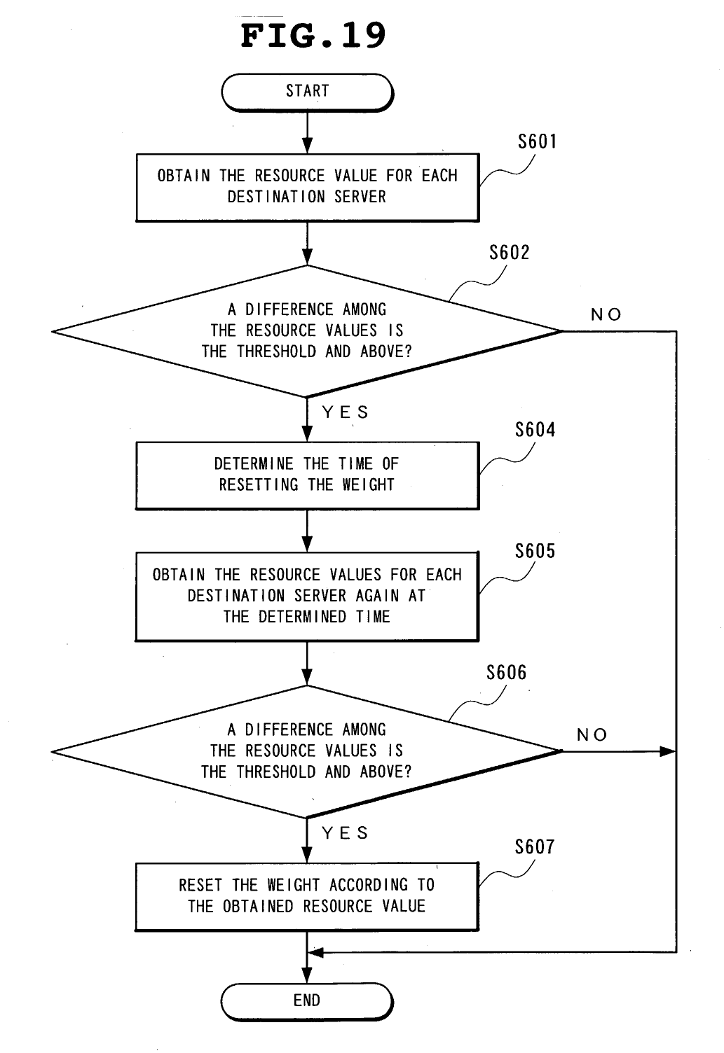

With reference to FIG. 19, the operation is the same as that having been described in FIG. 18 up to Step S602. When the difference among the resource values is the threshold and more in Step S602, the time of changing the weight value is determined (Step S604 in FIG. 19), instead of immediately changing the weight value in Step S603. The time of changing the weight value is determined with the probability, and, by way of example, the time between 0 minute later to ten minutes later may be determined with the equal probability.

The resource obtaining unit C11 obtains the resources as for the destination servers registered in every entry within the request routing table C18, once more (Step S605), at the time determined in Step S604. When obtaining the resources as for the respective destination servers again in Step S605, the same operation as that in Step S602 is performed again and it is checked whether a difference in the resource values among the respective servers is beyond a predetermined threshold or not (Step S606).

When the difference in the resource values among the servers is not beyond the predetermined threshold in Step S606, the processing is finished without changing the weight values set in the request routing table C18, while when it is beyond the threshold, the weight setting unit C19 resets the weight values (Step S607), depending on the resource values obtained again in Step S605.

In this operation, a rapid change in the number of the requests for a content server can be restrained by delaying the time of resetting the weight values by the time dispersed with the probability, instead of adjusting the move_granularity. It is judged whether the weight value should be reset again at the delayed time, and when it should not be reset, the reset operation is not performed, thereby restraining an unnecessary operation for changing the weight values and effectively preventing the oscillation.

The effects of the embodiment will be described.

In the embodiment, the weight values of the destination servers in each entry in the server load balancing device are respectively changed according to the obtained resource values. The weight values can be changed gradually by using the move_granularity, thereby restraining a rapid change in the number of the requests for a content server. Further, the same effect can be obtained by delaying the time of resetting the weight values by the time dispersed with probability, instead of adjusting the move_granularity. Although, in the third embodiment, a rapid change in the number of the requests is restrained on the side of a content server, in this embodiment, the same function can be realized on the side of a server load balancing device, with no need of a change on the side of the content server.

A fifth embodiment of the invention will be described in detail with reference to the drawings.

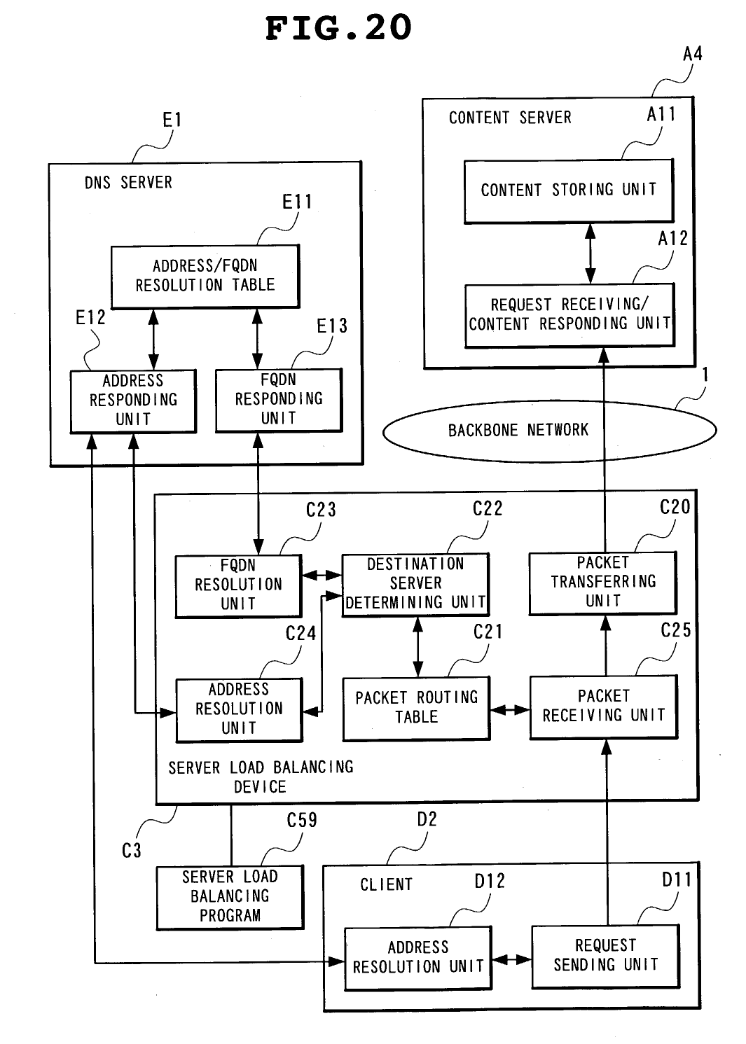

Referring to FIG. 20, the fifth embodiment of the invention is realized by a content server A4, a server load balancing device C3, a client D2, and a DNS server E1.

The content server A4 includes the content storing unit A11 and the request receiving/content responding unit A12. The respective functions and operations are the same as those of the second embodiment.

The server load balancing device C3 includes a packet receiving unit C25, a packet transferring unit C20, a packet routing table C21, a destination server determining unit C22, an FQDN (Fully Qualified Domain Name) resolution unit C23, and an address resolution unit C24.

The packet receiving unit C25 receives a packet from the client D2 and examines the destination port number of the packet. When the examined destination port number is included in a predetermined value, it examines the IP address of the content server A4 to which the packet should be transferred, according to the destination IP address of the same packet, referring to the entry registered in the packet routing table C21.

The packet transferring unit C20 rewrites the destination IP address of the packet received by the packet receiving unit C25 into the IP address of the content server A4 of the transfer target and transfers the packet to the content server A4.

Alternatively, the packet can be transferred by rewriting only the head at the layer 2 level, without rewriting the IP address. As the layer 2 protocol, when the case of using the Ethernet (R) is considered, the MAC address of the content server A4 is resolved by using ARP, from the IP address of the content server A4 of the destination, and the packet is transferred there with the resolved MAC address regarded as the destination MAC address, without rewriting the destination IP address of the packet. For brief description, hereafter, only the case of transferring the packet with the IP address rewritten will be described.

In the packet routing table C21, the IP addresses of the content servers where a packet should be transferred are registered respectively in accordance with the destination IP address/destination port number of each packet received by the packet receiving unit C23.

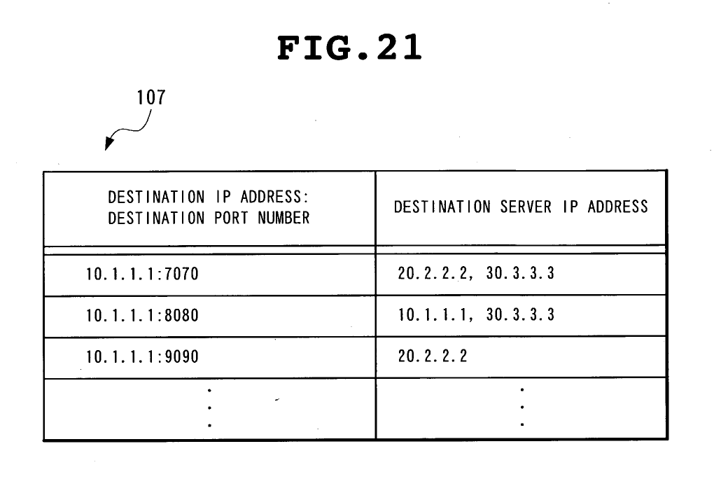

FIG. 21 is a table 107 showing one example of the packet routing table C21. According to the table 107, for example, the packet of the destination IP address “10.1.1.1” and the destination port number “7070” is transferred to the content server of the destination IP address “20.2.2.2” or the content server of the destination IP address “30.3.3.3”.

At this time, such a method as performing multiplication by the hash function in the same combination of the source IP address/source port number and selecting a content server based on the created hash value, is used in order to establish the same connection to the same content server, without alternately selecting the two content servers as for every packet. Further, there is also a method of memorizing so as to transfer a packet having the same IP address/port number as that of the packet to the same server, after the SYN flag reception of the TCP header of the received packet.

The destination server determining unit C22 determines a destination server (content server A4), as for a packet having some destination IP address/destination port number. The same method as that having been described in the destination server determining unit C13 in the second embodiment can be adopted to determine a destination server. The determined destination server is written into the entry of the packet routing table C21.

The FQDN resolution unit C23 inquires the FQDN as for the destination IP address of the DNS server E1, when the destination server determining unit C22 determines the content server A4 that is the destination of the packet having some destination IP address/destination port number.

When the destination server determining unit C22 determines the server that is the destination of the packet having some destination IP address, after the FQDN resolution unit C23 resolves the FQDN as for the destination IP address, the address resolution unit C24 newly creates FQDN by using the resolved FQDN and the destination port number of the packet, and resolves the IP address for the newly created FQDN. Here, the newly created FQDN must be unique for every destination IP address and destination port number of each packet. For example, when the resolved FQDN is “aaa.com” and the destination port number of the packet is “7070”, it resolves the IP address as for the FQDN “port7070.aaa.com”. Here, it is possible to resolve a plurality of IP addresses and a list of the IP addresses of the candidate servers of the packet destination can be obtained by using the FQDN resolution unit C23 and the address resolution unit C24.

The client D2 includes a request sending unit D11 and an address resolution unit D12.

The request sending unit D11 sends a request for obtaining the content as the IP packet. At this time, from URL that is an identifier of the requested content, the IP address corresponding to the FQDN of the URL is resolved by using the address resolution unit D12 and the resolved IP address is fixed as the destination IP address of the IP packet to be sent. The port number specified by the URL is fixed as the destination port number. For example, when sending a request for obtaining the content whose URL is “http://aaa.com/pict.jpg:7070”, assuming that the IP address as for “aaa.com” is “10.1.1.1”, the request sending unit D11 sends the packet of the destination IP address “10.1.1.1” and the destination port number “7070”.

The address resolution unit D12 inquiries the IP address of the DNS server E1 with the FQDN portion of the URL of the desired content as a key. A response from the DNS server E1 may include a plurality of IP addresses. In this case, one of any entry is used as the IP address corresponding to the FQDN.

The DNS server E1 includes an address/FQDN resolution table E11, and address responding unit E12, and an FQDN responding unit 13. The address/FQDN resolution table E11 is a table which is referred to when the address responding unit E12 and the FQDN responding unit E13 responds to an address resolution request and an FQDN resolution request being received, and it consists of two; an address resolution table 108 that is a conversion table of “FQDN→IP address” and an FQDN resolution table 109 that is a conversion table of “IP address→FQDN”.

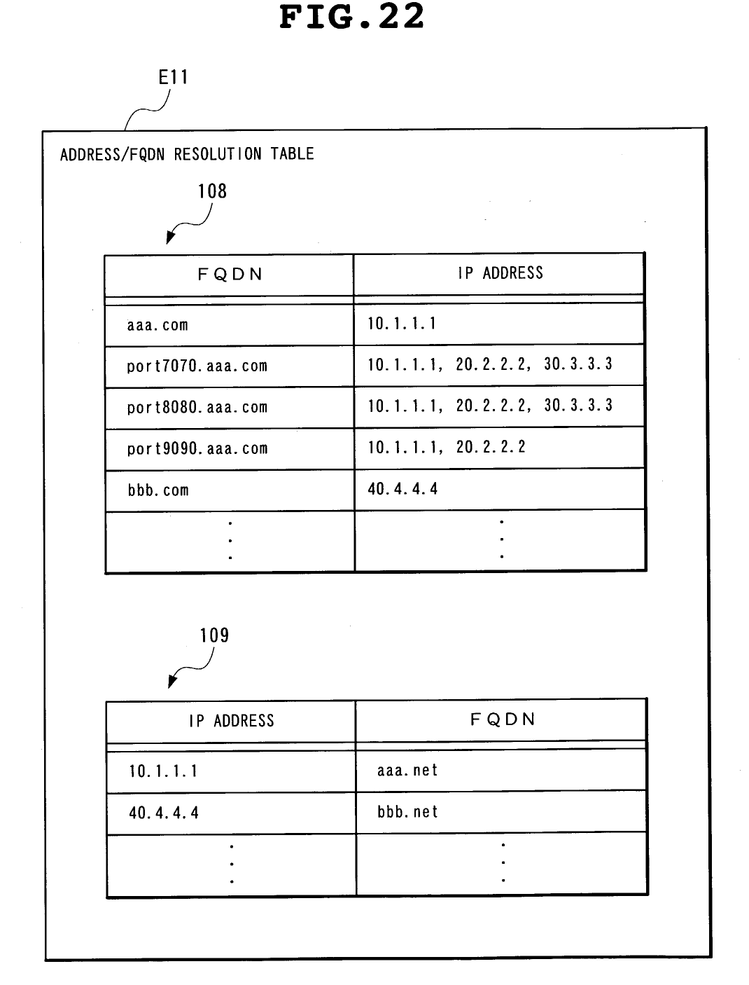

FIG. 22 shows an example of the address/FQDN resolution table E11. The address/FQDN resolution table E11 consists of two tables of the address resolution table 108 and the FQDN resolution table 109. A feature of the address/FQDN resolution table E11 is that there may exist a plurality of IP addresses resolved as for each FQDN in the address resolution table 108 but that one FQDN must be resolved as for one IP address in the FQDN resolution table 109.

At this time, use of the FQDN as the identifier of a content group enables the server load balancing device C3 to identify the requested content group by resolving the FQDN from the destination IP address and destination port number of a packet received from the client D2. Further, it can obtain a candidate server list as for the FQDN by resolving the IP address from the FQDN. Namely, only by the analysis of the IP header and the transport layer (UDP/TCP) header, the requested content group can be identified, and there is no need for further analysis of the information of the upper layer advantageously.

In reply to an address resolution request received from another node, the address responding unit E12 refers to the address/FQDN resolution table with the FQDN included in the request message as a key and returns the resolved IP address there.

In reply to an FQDN resolution request received from another node, the FQDN responding unit E13 refers to the address/FQDN resolution table with the IP address included in the request message as a key and returns the resolved FQDN there.

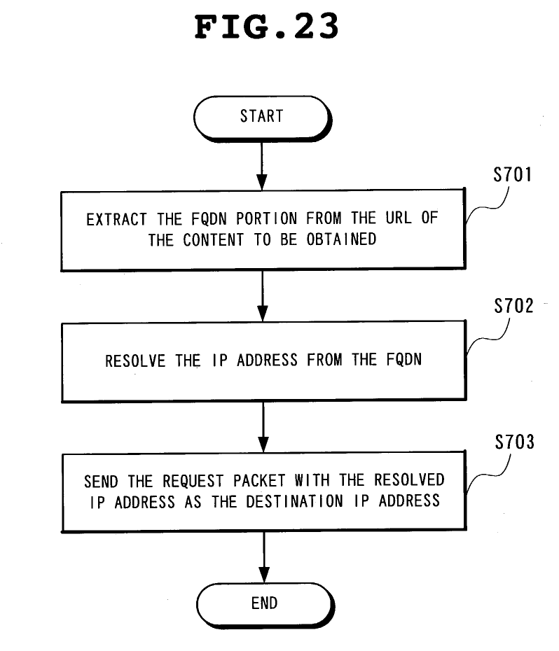

The operation when the client D2 sends a request for obtaining the content, in this embodiment, will be described in detail with reference to FIG. 23.

The request sending unit D11 extracts the FQDN portion from the URL of the desired content (Step S701 in FIG. 23). For example, assuming that the URL is “http://aaa.com/pict.jpg:7070”, “aaa.com” corresponds to the FQDN portion.

Next, the IP address corresponding to the extracted FQDN is resolved through the address resolution unit D12 (Step S702). Here, the address resolution unit D12 issues an address resolution request to the DNS server E1 with the FQDN as a key.

At last, the request sending unit D11 sends the request packet corresponding to the content with the resolved IP address fixed as the destination IP address (Step S703).

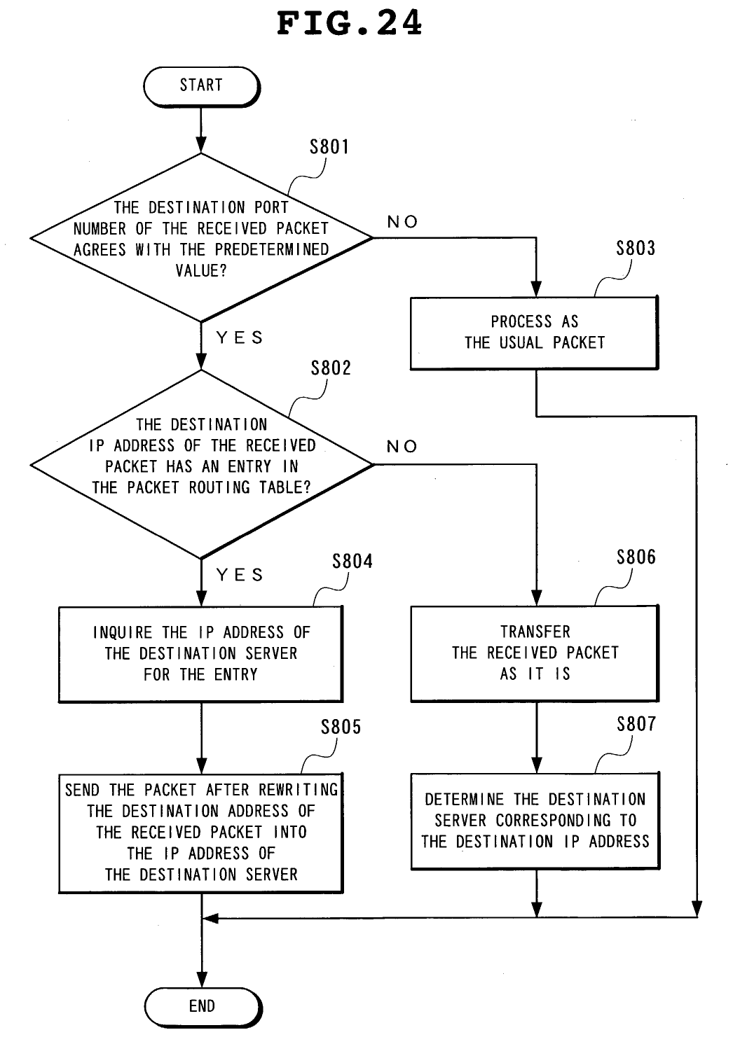

The operation when the server load balancing device C3 receives a packet from the client D2, in the embodiment, will be described in detail, with reference to FIG. 24.

The packet receiving unit C25 analyzes the destination port number of the received packet and checks whether the analyzed destination port number agrees with a predetermined value (Step S801 in FIG. 24).

As a result of Step S801, when it does not agree with the predetermined value, the packet receiving unit C25 processes the received packet as the usual packet (Step S803). Namely, the operation as the server load balancing device will not be performed.

As a result of Step S801, when it agrees with the predetermined value, the packet receiving unit C25 checks whether there exists an entry corresponding to the destination IP address/destination port number of the received packet within the packet routing table C21 (Step S802).

As a result of Step S802, when there exists such an entry, the packet receiving unit C25 inquires the destination server IP address in the entry of the packet routing table C21 (Step S804).

At this time, the packet routing table C21 returns the IP address of a destination server corresponding to the destination IP address/port number of the received packet. Here, when a plurality of destination server IP addresses are registered, the packet routing table C21 returns the IP address of a destination server in a way of establishing the same connection with the same content server, by using the hash function, as having been described in the above.

Upon receipt of the destination server IP address from the packet routing table C21, the packet receiving unit C25 rewrites the destination address of the received packet into the destination server IP address and sends the received packet there (Step S805).

As a result of Step S802, when there is no entry, the packet receiving unit C25 transfers the received packet to the original destination IP address as it is, without changing the destination IP address of the received packet (Step S806). Further, it determines the optimum destination server for a packet having the same destination IP address/destination port number and rewrites the entry into the packet routing table C21 (Step S807). After Step S806, until a destination server is written into the table C21 in Step S807, even if receiving a packet having the same destination IP address/destination port number, the packet receiving unit C25 transfers the packet to the original IP address as it is.

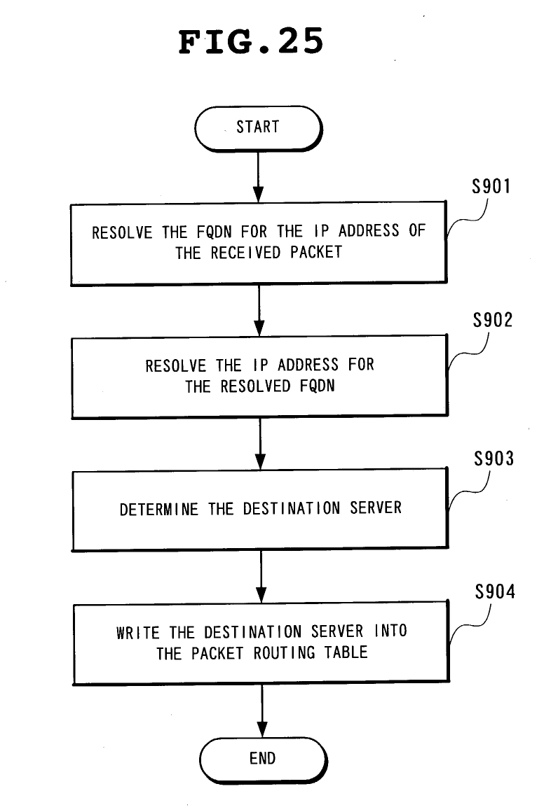

FIG. 25 is a flow chart for use in describing the operation in Step S807 in detail.

The destination server determining unit C22 resolves the FQDN for the destination IP address of the received packet through the FQDN resolution unit C23 (Step S901 in FIG. 25). At this time, the FQDN resolution unit C23 sends an FQDN resolution request to the DNS server E1 with the above IP address as a key and receives the reply.

When resolving the FQDN in Step S901, the destination server determining unit C22 newly creates an FQDN, by using the FQDN resolved in Step S901 and the destination port number of the packet, and resolves the IP address for the newly created FQDN (Step S902). Here, the newly created FQDN must be unique to a combination of the destination IP address and the destination port number of a packet. For example, when the resolved FQDN is “aaa.com” and the destination port number of the packet is “7070”, the destination server determining unit C22 resolves the IP address corresponding to the FQDN “port7070.aaa.com”.

In Step S902, although the FQDN resolved in Step S901 and the destination port number of the packet are used to create a new FQDN and the newly created FQDN is used as a key to resolve the IP address in the DNS server, there is a method of using the FQDN resolved in Step S901 as it is as a key. In this case, the FQDN itself resolved in Step S901 must be unique to the requested content group. Accordingly, it is necessary to fix a value unique to every content group in the destination IP address of a packet received by the server load balancing device C3. Further, in this case, in the packet routine table 21, the IP address of a destination server has to be registered in correspondence with only the destination IP address, not in correspondence with a combination of the destination IP address/destination port number.

The destination server determining unit C22 determines a destination server (Step S903), from the servers corresponding to the IP address resolved in Step S902. The detailed operation for determining a destination server is the same as that of the second embodiment, and its description is omitted.

When determining a destination server, the destination server determining unit C22 writes the IP address of the decided server into the packet routing table (Step S904).

The effects of the embodiment will be described.

In the embodiment, the server load balancing device identifies a content group to which the requested content belongs, by using the DNS server, according to the destination IP address/destination port number of a packet, and transfers the packet to the optimum content server within the content group. The conventional server load balancing device had to analyze the contents of a packet from a client and identify which content is requested. In other words, the conventional server load balancing device had to use the layer 7 switch. The server load balancing device of the embodiment, however, can identify which content is requested only by examining the destination IP address and destination port number of a packet. Accordingly, it can be realized by using the layer 4 switch. Generally, the throughput, of the layer 7 switch, such as the number of connections per one second, is lower and its cost is more expensive. If the same function can be realized with the layer 4 switch by use of this embodiment, it is every effective from the viewpoint of improving the throughput and decreasing the cost.

It is needless to say that the fifth embodiment can be combined with the content management device of the above-mentioned first embodiment. In this case, instead of the group URL, the port number is set in the classification policy table shown in FIG. 2. The directory path after grouping in FIG. 3 is replaced with a path with the port number added, “/cgi/highload/z.exe:7070”.

Hereinafter, the concrete example of the present invention will be described with reference to the drawings.

The first concrete example of the present invention will be described with reference to the drawings. This example corresponds to the second embodiment.

Referring to FIG. 7, this example is realized by a network formed by the content server A2, the server load balancing device C1, and the client D1.

Various policies indicated in the destination server determining policy table 103 of FIG. 8 are set in the destination server determining policy setting unit C12 within the server load balancing device C1. As an initial state, there is no entry registered in the request routing table C14.

The client D1 sends a request for obtaining the content recognized as the URL “http://www.aaa.com/file/small/pict.gif”, to a server.

The server load balancing device C1 receives the request and analyzes the requested URL. Referring to the request routing table C14, it transfers the request to a default content server because there is no entry corresponding to the above URL. The IP address resolved from the FQDN portion of the URL “www.aaa.com” by the DNS server is regarded as a default content server.

After transferring the request, the server load balancing device C1 tries to create an entry of a destination server corresponding to a content group to which the URL belongs, in the request routing table C14.

The destination server determining unit C13 inquires of the content management device for managing the content server A2 so as to obtain a content group and a candidate server list for the URL.

Upon receipt of the inquiry, the content management device answers that the content group corresponding to the URL has the file characteristic, it is recognized by the URL prefix “http://www.aaa.com/file/small/*”, and that the candidate server list includes three of “10.1.1.1”, “10.2.2.2”, and “10.3.3.3”.

As another method for obtaining the candidate server list corresponding to the URL, such an FQDN as “small.file.www.aaa.com” may be created from the URL and the corresponding IP address list with the FQDN as a key may be inquired of the DNS server. In this example, the DNS server answers that the IP address corresponding to the above FQDN includes three of “10.1.1.1”, “10.2.2.2”, and “10.3.3.3”.

The destination server determining unit C13 examines the destination server determining policy corresponding to the content group, referring to the destination server determining policy setting unit C12, and obtains such a policy as using the transfer throughput at a time of content acquisition for the content group having the file characteristic and with a server having the maximum value of the above throughput as a reference, selecting a server having 60% and more of the reference value as a destination server.

In order to measure the transfer throughput from each candidate server according to the obtained policy, the destination server determining unit C13 registers three IP addresses of “10.1.1.1”, “10.2.2.2”, and “10.3.3.3” in the request routing table C14, as the destination server for the request having the URL prefix “http://www.aaa.com/file/small/*”. After registration, each request corresponding to the above URL prefix from a client will be transferred to the three servers in a round robin method.

The response content from the content server in reply to each request transferred to the three servers in a round robin method is received by the content receiving/transferring unit C17. The resource obtaining unit C11 obtains the transfer throughput of this response content through the content receiving/transferring unit C17 and passes the obtained information to the destination server determining unit C13. Here, assume that the respective transfer throughput corresponding to “10.1.1.1”, “10.2.2.2”, and “10.3.3.3” are 1 Mbps, 7 Mbps, and 10 Mbps respectively. Since the policy is that with a server having its maximum value regarded as a reference, a server having 60% and more of the reference value is selected as the destination, the destination server determining unit C13 determines the two servers corresponding to “10.2.2.2” and “10.3.3.3” as the destination. Further, the destination server corresponding to the request having the URL prefix “http://www.aaa.com/file/small/*” in the request routing table C14 is rewritten into the above two “10.2.2.2” and “10.3.3.3”. Then, each request corresponding to the above URL prefix is transferred to the two servers in a round robin method.

A second concrete example of the present invention will be described with reference to the drawings. This example corresponds to the third embodiment of the present invention.

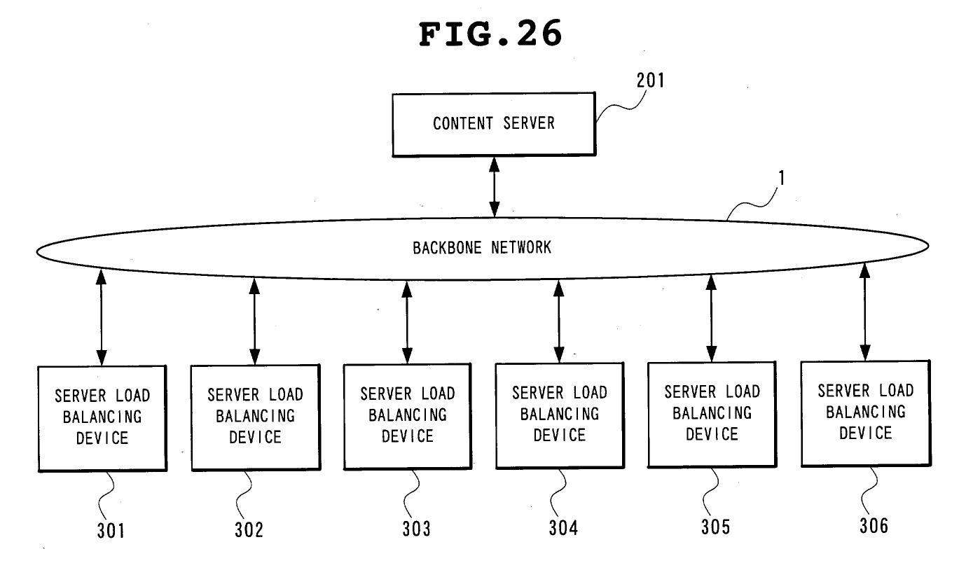

Referring to FIG. 26, the example is realized by a content server 201 and the server load balancing devices 301 to 306. The content server 201 has the same structure as that of the content server A3 of the third embodiment, and the server load balancing devices 301 to 306 respectively have the same structure as that of the server load balancing device C1 similarly.

The resource response policies shown in the resource response policy table 105 of FIG. 14 are set within the content server 201. Here, assume that the current CPU load is 25% in the content server 201.

In order to determine a destination server in the server load balancing devices 301 to 306, assume that the respective server load balancing devices issue the requests for obtaining resource of the CPU load to the content server 201 at once.

Since the current CPU load is within the range of 0% to 30%, as for the requests for obtaining resource from the first server load balancing devices 301 to 304, the content server 201 returns the actual CPU load with the probability of 70% and returns the twice value of the actual CPU load with the probability of 30%. Here, assume that it returns 25% that is the actual CPU load to the server load balancing devices 301 to 304 and that it returns 50% that is the twice value of the actual CPU load to the server load balancing devices 305 and 306.

When the content server 201 returns 25% that is the actual CPU load to the server load balancing devices 301 to 306, all the server load balancing devices may determine the content server 201 as the destination server, as a result of judging that the CPU load of the content server 201 is enough low, and there may occur a rapid increase in load owing to the rapid increase in the requests. In the example, however, the server load balancing devices 305 and 306 judge that the CPU load of the content server 201 is not enough low, and determine another content server except the content server 201 as the destination server. Therefore, a rapid increase in load can be restrained in the content server 201.

A third concrete example of the invention will be described with reference to the drawings. The example corresponds to the fourth embodiment of the present invention.

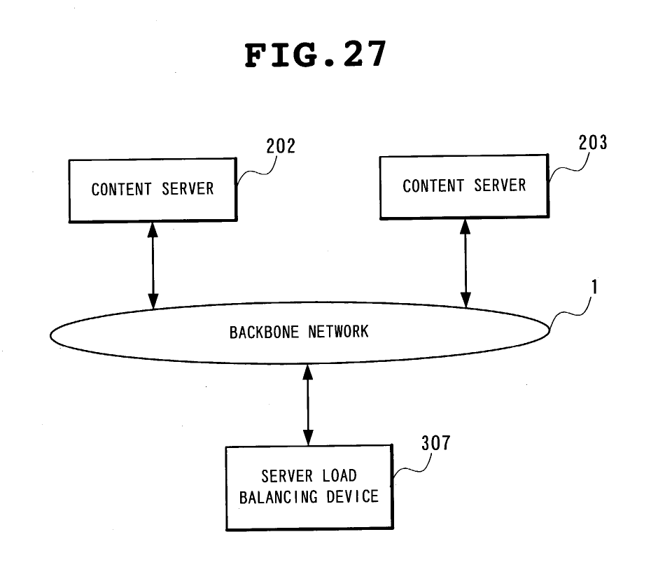

Referring to FIG. 27, the example is realized by the content servers 202 and 203 and the server load balancing device 307. The content servers 202 and 203 respectively have the same structure as that of the content server A2 in the fourth embodiment and the server load balancing device 307 has the same structure as that of the server load balancing device C2 similarly.

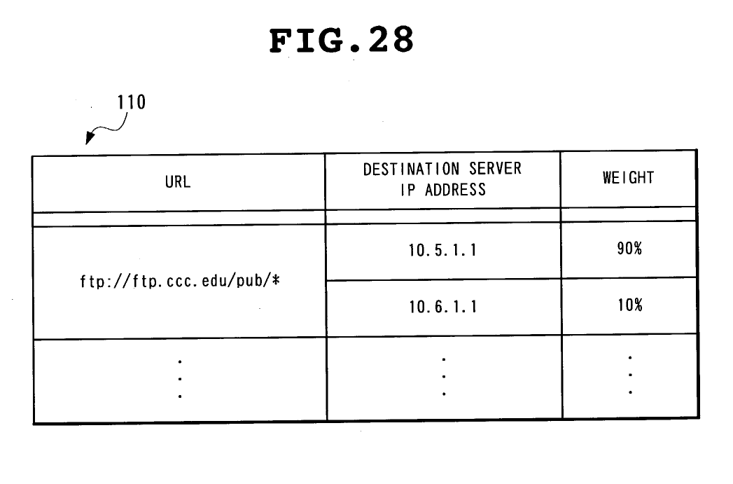

In the request routing table within the server load balancing device 307, as illustrated in the table 110 of FIG. 28, assume that there are two of “10.5.1.1” (corresponding to the content server 202) and “10.6.1.1” (corresponding to the content server 203) as the destination server IP address corresponding to “ftp://ftp.ccc.edu/pub/*” and that the respective weight values are 90% and 10%.

The weight is to be reset, according to the ratio of the transfer throughputs from the respective servers, until the transfer throughput of a server having the maximum throughput becomes less than the twice of the throughput of a server having the minimum throughput. Here, assume that the respective throughputs of the content servers 202 and 203 are 1 Mbps and 9 Mbps. Assuming that “move_granularity=1.0”, the weight values for the respective servers are reset at 90%→10% and 10%→90%. After resetting the weight, the ratio of the request transfer to the respective servers is changed and when measuring the transfer throughputs the next time, assume that the respective throughputs are 9 Mbps and 1 Mbps. Then, the weight is reset, to be returned to the initial values, like 10%→90% and 90%→10%. This recursive repetition of the weight changing operation and oscillation means that the move_granularity is too large.

Therefore, in the example, the case of “move_granularity=0.5” is considered. Assuming that the respective throughputs of the content servers 202 and 203 are 1 Mbps and 9 Mbps, the fluctuation amount of the weight value for each server is made 0.5 times of the case of “move_granularity=1.0” and the weight is reset at 90%→50% and 10%→50%. After the weight reset, the ratio of transferring a request for the respective servers is changed and when measuring the transfer throughput the next time, assume that the respective throughputs are 7 Mbps and 3 Mbps. Similarly, the respective weight values are reset at 50%→60% and 50%→40%. After the weight reset, the respective transfer throughputs for the respective servers become 6 Mbps and 4 Mbps, since the transfer throughput of the server having the maximum transfer throughput becomes less than the twice value of the server having the minimum transfer throughput, the weight changing operation is finished. Thus, it is important to adjust the move_granularity at a proper value so as not to oscillate the weight changing operation.

A fourth concrete example of the present invention will be described with reference to the drawings. The example corresponds to the fifth embodiment of the present invention.

Referring to FIG. 20, the example is realized by a network formed by the content server A4, the server load balancing device C3, the client D2, and the DNS server E1.

The address resolution table 108 and the FQDN resolution table 109 shown in FIG. 22 are registered within the DNS server E1.

No entry is registered in the packet routing table C21 within the server load balancing device C3 in the initial state.

The client D2 tries to send a request for obtaining the content recognized as the URL “http://aaa.com/pict.jpg:7070” to a sever. Here, the address resolution request is issued to the DNS server E1 with the FQDN portion of the URL “aaa.com” as a key. The DNS server E1 returns the corresponding IP address “10.1.1.1”. The client D2 regards the resolved “10.1.1.1” as the destination IP address and sends the request in a form of a packet having the destination port number “7070” specified in the URL.

The server load balancing device C3 receives the packet from the client D2 and transfers the packet having a predetermined destination port number to a destination server IP address, referring to the packet routing table C21. In this case, the “7070” is the predetermined destination port number, the packet routing table C21 is checked, to be found no registered entry, and therefore, it transfers the packet to the original destination IP address as it is.

After transferring the packet, the server load balancing device C3 tries to create an entry of a destination server in the content group corresponding to the packet, in the packet routing table C21. Even if receiving a packet having the same destination IP address/destination port number as that of the above packet, it transfers the packet to the original destination IP address, until creating an entry of a destination server.

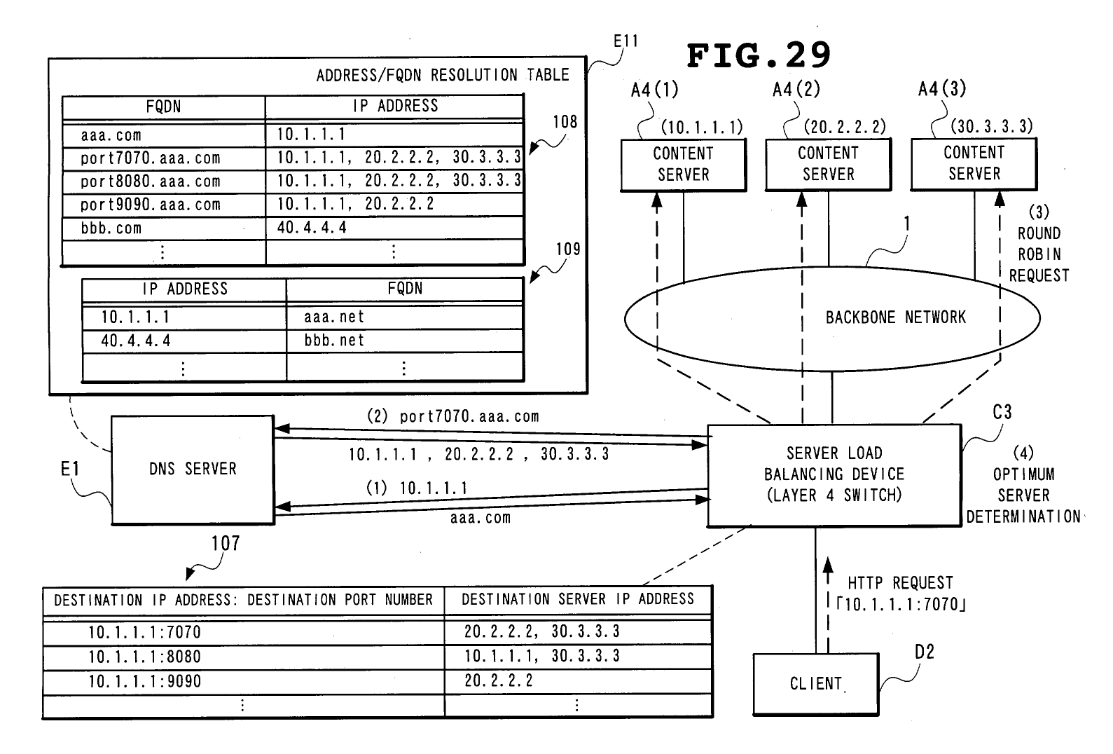

An example of the case of creating an entry of a destination server for the content group corresponding to a packet in the packet routing table C21 will be described with reference to FIG. 29. A request is sent from the client D2 in a form of a packet with the destination IP address “10.1.1.1” and the destination port number “7070” specified by the URL as mentioned above.

The destination server determining unit C22 of the server load balancing device C3 requests the FQDN resolution of the DNS server E1 with the destination IP address “10.1.1.1” of the packet as a key, through the FQDN resolution unit C23.

Upon receipt of the request, the FQDN responding unit E13 of the DNS server E1 answers the FQDN “aaa.com” for “10.1.1.1”.

The destination server determining unit C22 requests the address resolution of the DNS server E1, with the FQDN “port7070.aaa.com” as a key, through the address resolution unit C24. The above FQDN is formed by attaching the information of the destination port number “7070” to the FQDN “aaa.com” returned from the DNS server E1. The FQDN newly created here must be unique to the destination IP address and the destination port number of the packet, and as another example, “7070.port.aaa.com” may be used. The entry corresponding to the FQDN to be created must be registered in the DNS server E1.

Upon receipt of the request, the address responding unit E12 of the DNS server E1 answers the addresses “10.1.1.1”, “20.2.2.2”, and “30.3.3.3” corresponding to the “port7070.aaa.com”.

Accordingly, the destination server determining unit C22 knows that the packet of the destination IP address/destination port number “10.1.1.1/7070” has the three destination IP addresses of the candidate servers “10.1.1.1”, “20.2.2.2”, and “30.3.3.3”.

The destination server determining unit C22 determines a destination server to be registered in the packet routing table, from the candidate servers. Here, assume that such a policy as selecting two servers in the increasing order of the CPU load is set as the determining policy of a destination server, and that as a result of the inquiry of each server, the respective CPU loads of the servers corresponding to “10.1.1.1”, “20.2.2.2”, and “30.3.3.3” respectively are 80%, 30%, and 50%.

As a result, the destination server determining unit C22 determines the server corresponding to “20.2.2.2” and the server corresponding to “30.3.3.3” as the destination server, as for the packet of the destination IP address/destination port number “10.1.1.1/7070” and registers the above both in the packet routing table C21 (refer to the packet routing table 107 in FIG. 21).

After entry registration into the packet routing table C21, a packet having the destination IP address/destination port number “10.1.1.1/7070” will be redirected to the server of the IP address “20.2.2.2” or “30.3.3.3”.

In the server load balancing system of each of the above embodiments, it is needless to say that the functions of the destination server determining policy setting unit C12, the destination server determining units C13 and C22, the FQDN resolution unit C23, and the address resolution unit C24 in the server load balancing devices C1 to C3, the functions of the content classification unit B12 and the content grouping unit B13 in the content management device B1, the functions of the resource responding units A13 and A15 and the resource response policy setting unit A14 in the content servers A1 to A4, and the other functions can be realized by the hardware, and a content delivery management program A39, a content management program B19, server load balancing programs C29, C49, and D59 having each function can be loaded into a memory of a computer, thereby realizing the above system. The content deliver management program A39, the content management program B19, and the server load balancing programs C29, C49, and C59 are stored in a storing medium such as a magnetic disk and a semiconductor memory. They are loaded into a computer from the storing medium so as to control the operation of the computer, thereby realizing the above-mentioned functions.

As set forth hereinabove, the present invention has been described by using the preferred embodiments and examples, but the present invention is not restricted to the above embodiments and examples but various modifications can be made within the scope and sprit of the invention.

As mentioned above, according to the present invention, the following effects can be achieved.

At first, it is not necessary to manually classify and group the content within a content server into every content having the same characteristic.

This is because each policy for classifying/grouping the content as the same content group is set in the content management device, thereby automatically grouping it according to the static/dynamic characteristics of the content within the content server.

At second, in the server load balancing device, the optimum request routing depending on the characteristic of the content can be realized by the minimum number of entries.

This is because the content management device automatically classifies and groups the content within the content server according to the static/dynamic characteristics thereof.

At third, by passing through the server load balancing device, a request from a client can be transferred to the optimum server depending on the characteristic of the requested content.

This is because the server load balancing device determines a destination server according to selection criteria depending on each characteristic for every content group, registers the determined destination server into the request routing table, and identifies which content group includes the requested content from a client, thereby transferring the request to a destination server for the corresponding content group.

At fourth, a rapid concentration of the requests from the clients on the content server can be restrained and the determining operation of a destination server can be prevented from oscillating without convergence in the request routing table of the server load balancing device.

This is firstly because in reply to a request for obtaining the resource information from a plurality of server load balancing devices disposed within a network in the content server, the actual resource information is not always returned there but the resource value calibrated depending on the set resource response policy is returned, thereby restraining a lot of server load balancing devices from selecting the same content server as a destination simultaneously.

This is secondly because in the server load balancing device, the weight value for each destination server of each entry is changed according to the obtained resource value, and this change of the weight value is smoothly performed by using move_granularity, thereby restraining a lot of server load balancing devices from selecting the same content server as a destination simultaneously.

This is thirdly because in the server load balancing device, instead of immediately resetting the weight value for each destination server of each entry according to the obtained resource value, the time to reset the weight value is delayed by the time distributed with the probability and if necessary, the weight value is reset at the delayed time, thereby restraining a lot of server load balancing devices from selecting the same content server as a destination simultaneously.

At fifth, the server load balancing device can lead a request from a client to the optimum content server by using the layer 4 switch without using the layer 7 switch, thereby improving the performance and decreasing the cost as the server load balancing device.

This is because in the server load balancing device, the content group including the requested content is identified from the destination IP address/destination port number of a packet received from a client, by using the DNS server, and the packet is transferred to the optimum content server corresponding to the content group, thereby skipping the analysis of the contents (URL, etc.) of the packet from the client.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

In the claims:

1. A server load balancing system for distributing a content deliver to a client among a plurality of content servers, comprising:
means for determining said content server to which a destination of a content delivery request received from the client is to be transferred, by using at least characteristic of the content and resource information about said content server.

2. The server load balancing system, as set forth in claim 1, wherein
said content server to which said content delivery request received from said client is to be transferred is determined again according to a change of said resource information.

3. The server load balancing system, as set forth in claim 1, wherein
said content delivery request received from said client is transferred to said content server to which said content delivery request is to be transferred, said content server being set for said content.

4. The server load balancing system, as set forth in claim 1, wherein
based on a destination IP address and a destination port number of a packet received from said client, said content requested by said client is recognized and said packet is transferred to said content server set for said content.

5. The server load balancing system, as set forth in claim 1, wherein
said content delivered by said content server is classified into a plurality of groups depending on said characteristic of said content, and said content classified into the above groups is collected together into every group.

6. A server load balancing device for selecting a content server that delivers content to a client, from a plurality of content servers, comprising:
means for determining said content server to which a content delivery request received from said client is to be transferred, by using at least characteristic of said content and resource information about said content server.

7. The server load balancing device, as set forth in claim 6, wherein
said resource information includes at least one or a plurality of resource parameters, a second resource parameter different from a first resource parameter is predicted or extracted by using said first resource parameter, and said resource information includes said second resource parameter predicted or extracted.

8. The server load balancing device, as set forth in claim 6, wherein
said destination server determining means
obtains a candidate content server for a destination of said request, by using a URL or a portion of the URL of said content requested from said client, and
determines said content server to which said content is delivered, from said candidate content server.

9. The server load balancing device, as set forth in claim 8, wherein
said portion of said URL is a URL prefix that is head portion of said URL or a file extension in said URL or a combination of the both.

10. The server load balancing device, as set forth in claim 6, wherein
said destination server determining means
obtains said candidate content server for delivering said content requested from said client, by inquiring of said content servers existing within said network or a content management device that is a device for managing said content within said content servers.

11. The server load balancing device, as set forth in claim 6, wherein
said destination server determining means
obtains characteristic of said client, by inquiring of said content servers existing within said network or a content management device that is a device for managing said content within said content servers.

12. The server load balancing device, as set forth in claim 6, wherein
said destination server determining means
creates an FQDN by using a URL or a portion of the URL of said content to be obtained by said request,
obtains a list of IP address for said FQDN with the FQDN as a key, and
defines a content server corresponding to each IP address of the list as said candidate content server for delivering said content requested from said client.

13. The server load balancing device, as set forth in claim 12, wherein
said list of IP address for said FQDN is obtained from a DNS server.

14. The server load balancing device, as set forth in claim 6, wherein
a packet for requesting said content deliver, which is sent by said client is transferred to said content server, after changing said destination IP address of said packet to said IP address of said content server determined as said content server for delivering said content to said client.

15. The server load balancing device, as set forth in claim 6, wherein
a packet for requesting said content deliver, which is sent from said client, is transferred to said content server, after resolving a MAC address corresponding to said IP address of said content server determined as said content server for delivering said content to said client and changing said MAC address of said packet to said resolved MAC address.

16. The server load balancing device, as set forth in claim 6, wherein
said content server to which said delivery request of said content received from said client is to be transferred is again determined according to a change of said resource information.

17. The server load balancing device, as set forth in claim 6, wherein
priority is set at said respective content servers to which said delivery request of said content received from said client is to be transferred, by using at least said characteristic of said content and said resource information.

18. The server load balancing device, as set forth in claim 17, wherein
said priority is set again according to a change of said resource information.

19. The server load balancing device, as set forth in claim 18, wherein
in consideration of said current priority, before resetting said priority according to said resource information of said respective content servers, a fluctuation from said current priority is restrained to a constant degree, and then said priority is reset.

20. The server load balancing device, as set forth in claim 6, wherein
said time of resetting said priority is delayed by a time varying in probability and said priority is reset at said delayed time.

21. The server load balancing device, as set forth in claim 20, wherein
at said delayed time, whether said priority is reset or not is judged again and when judging that said priority is reset, said priority is reset again.

22. The server load balancing device, as set forth in claim 6, comprising
means for determining said content server for sending said content to said client, based on a destination IP address and destination port number of a packet for requesting a content deliver, received from said client, and transferring said received packet for requesting said content delivery, to said determined content server, wherein
an FQDN indicating said destination IP address and destination port number uniquely is newly created by using said information of said destination IP address and destination port number of said received packet,
a candidate content server for delivering said content to said client, which server is said transfer destination of said received packet is obtained by inquiring of a DNS server with said newly created FQDN as a key, and
said content server for delivering said content to said client is determined from said candidate.

23. The server load balancing device, as set forth in claim 22, wherein
said FQDN is resolved by inquiring of said DNS server with said destination IP address as a key,
an FQDN uniquely indicating said destination port number and said resolved FQDN is newly created by using said information of said resolved FQDN and said destination port number,
a list of IP address resolved by inquiring of said DNS server with said newly created FQDN as a key is defined as a candidate content server for delivering said content to said client, and
said content server for delivering said content to said client is determined from said candidate.

24. The server load balancing device, as set forth in claim 22, wherein
said FQDN is resolved by inquiring of said DNS server with said destination IP address as a key,
a list of IP address resolved by inquiring of said DNS server with said resolved FQDN as a key is defined as a candidate content server for delivering said content to said client, and
said content server for delivering said content to said client is determined from said candidate.

25. The server load balancing device, as set forth in claim 22, comprising
packet receiving means for receiving a packet for requesting a content delivery, from said client, and
packet transferring means for rewriting said destination IP address of said packet received by said packet receiving means into said IP address of said content server for delivering said requested content to said client and transferring the same to said content server.

26. The server load balancing device, as set forth in claim 25, wherein
said packet transferring means
resolves a MAC address corresponding to said IP address of said content server for delivering said requested content to said client, and
transferring said packet to said content server, after rewriting said destination MAC of said packet for requesting said content delivery, received by said packet receiving means, into said resolved MAC address.

27. A content server for delivering content, comprising
means for notifying a calibrated value of an actual resource value calculated as resource information, of a node for selecting a delivery destination of said content based on said resource information about each server.

28. A content management device for managing content delivered by a content server, comprising
content classification means for classifying said content which said content server delivers, into a plurality of groups, according to characteristic of said content, and
content grouping means for collecting together said content classified into said groups, in every group.

29. The content management device, as set forth in claim 28, wherein
said content classification means classifies said content by said characteristics.

30. The content management device, as set forth in claim 28, wherein
said content classification means gradually classifies said content step by step, according to a hierarchical structure of gradually fining granularity of classification of said characteristics of said content.

31. The content management device, as set forth in claim 28, wherein
said content grouping means collects together said content classified into the same group, under a same directory.

32. A server load balancing program for distributing a content delivery to a client among a plurality of content servers, by controlling a computer, comprising
a function of referring to selection criteria of said content server with correspondence between characteristics of said content and resource information about said content servers, and
a function of determining said content server for delivering said content requested from said client, based on said selection criteria, according to said resource information and said characteristic of said requested content.

33. A content delivery management program for managing a content delivery of a content server for delivering content, by controlling a computer, comprising
a function of notifying a calibrated value of an actual resource value calculated as usable resource information at this point, to a node for selecting a delivery destination of said content according to said resources of said servers.

34. A content management program for managing content which a content server delivers, by controlling a computer, comprising
a content classification function for classifying said content which said content server delivers into a plurality of groups, according to said characteristics of said content, and
a content grouping function for collecting together said content classified into said groups, in every group.
